(19) United States
(12) Patent Application Publication
(10) Pub. No.: US 2026/0320111 A1
(43) Pub. Date: Oct. 15, 2026

(54) Object Centric Generative Model Media Generation

(71) Applicant: Google LLC, Mountain View, CA (US)

(72) Inventor: Yuanzhen Li, Newton Centre, MA (US)

(21) Appl. No.: 19/473,882

(22) PCT Filed: May 17, 2024
(86) PCT No.: PCT/US2024/030017

§ 371 Date: Oct. 9, 2025

Related U.S. Application Data
(60) Provisional application No. 63/503,556, filed on May 22, 2023.

(51) Int. Cl. G06F 16/535; G06F 16/532; G06F 16/538; G06T 11/60

(52) U.S. Cl. CPC G06F 16/535; G06F 16/532; G06F 16/538; G06T 11/60

(57) ABSTRACT

Systems and methods for object centric generative model media generation can include obtaining one or more input images associated with the object and processing the one or more input media content items with a generative model to generate one or more model-generated media content items. Processing the one or more input media content items with a generative model can include tuning one or more parameters for object-specific rendering and can include utilizing the object-specific tuning to render the object in one or more different environments.

### RELATED APPLICATIONS

The present application is based on and claims priority to U.S. Provisional Application No. 63/503,556 having a filing date of May 22, 2023. Applicant claims priority to and the benefit of each of such application and incorporates all such applications herein by reference in its entirety.

### FIELD

The present disclosure relates generally to object centric image generation. More particularly, the present disclosure relates to processing input images associated with an object to tune parameters of a generative model and to generate model-generated images of the object with the tuned generative model.

### BACKGROUND

Viewing an object in different scenes and/or with other objects can inspire a user. The user may be inspired to obtain and/or use an object for a particular task based on how an object is displayed in an image and/or with what an object is displayed within an image. For example, product placement can be utilized to market different products and can provide users with an imagined use and/or location of use for the given product. Marketing campaigns can be expensive and time consuming, which may lead to limited diversity in the images of particular products.

Additionally, generative model image generation can cause some objects and/or details to be rendered irregularly. For example, the size proportions may be rendered inaccurately, and/or artifacts and/or other abnormalities may be rendered. For instances in which a user desires an object to be rendered accurately as a showcase for the object, traditional generative models alone may not provide a desired outcome.

### SUMMARY

Aspects and advantages of embodiments of the present disclosure will be set forth in part in the following description, or can be learned from the description, or can be learned through practice of the embodiments.

One example aspect of the present disclosure is directed to a computing system for image generation. The system can include one or more processors and one or more non-transitory computer-readable media that collectively store instructions that, when executed by the one or more processors, cause the computing system to perform operations. The operations can include obtaining input data. The input data can include one or more input images. In some implementations, the one or more input images can be descriptive of a particular object. The operations can include processing input data with an image generation model to generate output data. The image generation model may have been trained to generate a set of model-generated images based on an input. The output data can include a plurality of output model-generated images. The plurality of output model-generated images can be descriptive of the particular object in one or more environments. Processing input data with the image generation model to generate the output data can include tuning a set of parameters of the image generation model based on the one or more input images, embedding an association between a model-readable token and the set of parameters within the image generation model, generating a plurality of prompts that include the model-readable token, and generating, by processing the plurality of prompts with the image generation model, the plurality of output model-generated images based at least in part on the set of parameters tuned based on the one or more input images. In some implementations, the set of parameters can render the particular object based on the image generation model processing the model-readable token. The operations can include providing at least a subset of the plurality of output model-generated images as output.

In some implementations, the one or more environments can differ from one or more background environments of the one or more input images. The operations can include processing the plurality of output model-generated images and the one or more input images to determine an object metric for each of the plurality of output model-generated images. The object metric can be descriptive of a determined similarity between the particular object as depicted in the one or more input images and the particular object as depicted in a respective output model-generated image of the plurality of output model-generated images. The operations can include determining the subset of the plurality of output model-generated images to output based on the plurality of object metrics.

In some implementations, the operations can include processing the plurality of output model-generated images to determine a realism metric for each of the plurality of output model-generated images. The realism metric can be descriptive of a determined realism of a respective output model-generated image of the plurality of output model-generated images. The operations can include determining the subset of the plurality of output model-generated images to output based on the plurality of realism metrics. In some implementations, the image generation model can include a plurality of multi-layer perceptron blocks to perform color prediction and density prediction for object rendering.

In some implementations, tuning the set of parameters can include generating a first model-generated image with the image generation model, evaluating a loss function that evaluates a difference between the first model-generated image and the one or more input images, and adjusting one or more parameters of the set of parameters based at least in part on the loss function. The operations can include obtaining a search query, determining the search query is associated with the particular object, and providing one or more output model-generated images of the plurality of output model-generated images for display in a search results interface.

In some implementations, the operations can include obtaining content data from a user computing system. The content data can be descriptive of one or more content items accessed by the user computing system. The operations can include determining the content data is associated with the particular object and providing one or more output model-generated images of the plurality of output model-generated images to the user computing system. In some implementations, the input data can include a first set of input images associated with a first object and a second set of images associated with a second object. The plurality of output model-generated images can be descriptive of the first object and the second object in the one or more environments. The image generation model can include at least one of a diffusion model or a token-based transformer model.

Another example aspect of the present disclosure is directed to a computer-implemented method for generating model-generated images with an object. The method can include obtaining, by a computing system including one or more processors, a plurality of input images. Each of the plurality of input images can depict the object. The method can include obtaining, by the computing system, a pre-trained image generation model. The pre-trained image generation model may have been trained to process an input and generate an output image that comprises predicted pixels. The method can include adjusting, by the computing system, a set of parameters based on the plurality of images and the pre-trained image generation model. The method can include associating, by the computing system, the set of parameters with a unique identifier and generating, by the computing system, a plurality of prompts comprising the unique identifier and a plurality of different terms associated with a plurality of different settings. The method can include generating, by the computing system, a plurality of model-generated images with the set of parameters and the pre-trained image generation model based on processing the plurality of prompts with the pre-trained image generation model and the set of parameters. In some implementations, the plurality of model-generated images can include predicted image data that depicts the object in one or more environments. The method can include providing, by the computing system, at least a subset of the plurality of model-generated images as output.

In some implementations, the set of parameters can be different from a plurality of pre-tuned parameters of the pre-trained image generation model. Adjusting, by the computing system, the set of parameters based on the plurality of images and the pre-trained image generation model can include generating a plurality of training output images with the pre-trained image generation model and the set of parameters, evaluating a loss function that evaluates a difference between one or more respective training output images of the plurality of training output images and one or more of the plurality of input images, and adjusting one or more parameters of the set of parameters based at least in part on the loss function.

In some implementations, generating the plurality of training output images with the pre-trained image generation model and the set of parameters can include obtaining a prompt associated with the object and processing the prompt with the pre-trained image generation model and the set of parameters to generate the plurality of training output images. The object can be rendered based on the set of parameters in response to the pre-trained image generation model processing the unique identifier. The prompt can include text data and the unique identifier. In some implementations, the plurality of input images can depict the object from different perspectives. The plurality of input images can depict the object in different environments.

Another example aspect of the present disclosure is directed to one or more non-transitory computer-readable media that collectively store instructions that, when executed by one or more computing devices, cause the one or more computing devices to perform operations. The operations can include obtaining a plurality of input images. The plurality of input images can be descriptive of a particular object. The operations can include obtaining a pre-trained text-to-image generative model. The pre-trained text-to-image generative model may have been trained to process an input and generate an output image that includes predicted pixels. The operations can include processing the plurality of input images with the pre-trained text-to-image generative model to adjust one or more parameters to generate a specialized text-to-image model and to generate a unique identifier associated with the particular object. The specialized text-to-image model can be trained to generate image data associated with the particular object in response to processing the unique identifier. The operations can include obtaining a prompt. The prompt can include text data and the unique identifier. The operations can include processing the prompt with the specialized text-to-image model to generate one or more model-generated images. In some implementations, the one or more model-generated images can include the particular object in an environment. The environment can be generated based at least in part on the text data. The operations can include providing the one or more model-generated images as output.

In some implementations, the text data can be descriptive of a request for a particular type of environment to be rendered. The environment of the one or more model-generated images can be of the particular type of environment. The unique identifier can include at least one of a set of characters or one or more embedding values. In some implementations, the one or more model-generated images can include the particular object depicted in a different perspective from the one or more particular perspectives of the plurality of input images.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a block diagram of an example image generation system according to example embodiments of the present disclosure.

FIG. 2A depicts a block diagram of an example object-specific image generation system according to example embodiments of the present disclosure.

FIG. 2B depicts a block diagram of an example foreground-background image generation system according to example embodiments of the present disclosure.

FIG. 3 depicts a flow chart diagram of an example method to perform synthetic image generation according to example embodiments of the present disclosure.

FIG. 4 depicts a block diagram of an example specialized generative model generation and inference system according to example embodiments of the present disclosure.

FIG. 5A depicts a block diagram of an example model tuning and inference system according to example embodiments of the present disclosure.

FIG. 5B depicts illustrations of example inputs and outputs that include a particular pair of sunglasses according to example embodiments of the present disclosure.

FIG. 5C depicts illustrations of example inputs and outputs that include a particular teapot according to example embodiments of the present disclosure.

FIG. 5D depicts illustrations of example inputs and outputs for comic strip generation according to example embodiments of the present disclosure.

FIG. 5E depicts illustrations of example inputs and outputs for multi-object rendering according to example embodiments of the present disclosure.

FIG. 6 depicts a block diagram of an example object specific parameter tuning system according to example embodiments of the present disclosure.

FIG. 7 depicts a flow chart diagram of an example method to perform image generation model tuning and inference according to example embodiments of the present disclosure.

FIG. 8 depicts a flow chart diagram of an example method to perform generative model tuning and inference according to example embodiments of the present disclosure.

FIG. 9 depicts a block diagram of an example object understanding system according to example embodiments of the present disclosure.

FIG. 10 depicts a block diagram of an example neural radiance field model training according to example embodiments of the present disclosure.

FIG. 11 depicts a block diagram of an example soft prompt tuning system according to example embodiments of the present disclosure.

FIG. 12A depicts a block diagram of an example computing system that performs model-generated image generation according to example embodiments of the present disclosure.

FIG. 12B depicts a block diagram of an example computing system that performs model-generated image generation according to example embodiments of the present disclosure.

Reference numerals that are repeated across plural figures are intended to identify the same features in various implementations.

### DETAILED DESCRIPTION

Generally, the present disclosure is directed to generating novel renderings of an object in different environments. One or more images of the object can be utilized to train a set of parameters to generate renderings of the object in output images. The set of parameters and a generative image generation model can then be utilized to generate a plurality of images of the particular object in one or more environments that may differ from the environments depicted in the input images.

For example, a set of input images depicting an object can be received. The set of input images can include the object from different angles and/or in different environments.

The set of input images can be utilized to adjust one or more parameters of a generative model (e.g., a text-to-image generative model) to train the generative model to render that specific object. The tuned generative model can then be utilized to generate a plurality of model-generated images that depict the object in different environments, which can include different locations, lighting, and/or with different objects. The generation of the model-generated images may be based on a prompt provided to and processed with the tuned generative model. The prompt may include a unique identifier associated with the object and/or may include a request for a particular environment to render the objects in for the model-generated images.

The generative model may be conditioned for one object or a set of objects, which can be utilized to generate model-generated images that include an ensemble of the objects in one or more environments. The tuned generative model may be utilized to generate novel view renderings of the object and/or for depicting the object in different lighting.

The systems and methods disclosed herein can be utilized to showcase an object and/or a set of objects in different environments with different backgrounds (e.g., different settings) and/or different additional objects (e.g., different object ensembles). The object can be rendered accurately and realistically while being displayed in various environments that may inspire a user to utilize the object in a particular location and/or in a particular manner. In particular, the systems and methods can use computer vision and machine learning (e.g., object shape/pose/reflectance estimation, object-conditioned generative models, etc.) to automatically generate hero/showroom images at scale, and in a personalizable and targetable manner.

Viewing an object in different scenes and/or with other objects can inspire a user. The user may be inspired to obtain and/or use an object for a particular task based on how an object is displayed in an image and/or with what an object is displayed within an image. For example, product placement can be utilized to market different products and can provide users with an imagined use and/or location of use for the given product. Marketing campaigns can be expensive and time consuming, which may lead to limited diversity in the images of particular products. Additionally, generative model image generation can cause some objects and/or details to be rendered irregularly. For example, the size proportions may be rendered inaccurately, and/or artifacts and/or other abnormalities may be rendered. For instances in which a user desires an object to be rendered accurately as a showcase for the object, traditional generative models alone may not provide a desired outcome.

The systems and methods disclosed herein can depict an object and/or a plurality of objects in different scenes and/or with different objects without the time consumption and/or cost of physically setting up, scheduling, and performing a photography shoot.

Additionally and/or alternatively, the systems and methods disclosed herein can provide object showcasing to individuals that may not traditionally be able to access the locations and/or costs utilized in traditional object showcasing.

Additionally and/or alternatively, the systems and methods disclosed herein can obtain one or more images of an object, obtain a pre-trained generative model (e.g., a pre-trained image generation model), and generate a specialized generative model that is specialized to render the object(s) in different environments. The generation of the specialized generative model can include adding and tuning additional parameters to the pre-trained generative model and/or adjusting a limited number of parameters of the pre-trained generative model to generate accurate and realistic renderings of the object(s). The object-specific parameter tuning can mitigate proportion inaccuracies and/or artifacts when rendering the object, while continuing to leverage the predictive capabilities of the pre-trained generative model.

In some implementations, one or more input images of a particular object can be obtained and processed with a pre-trained image generation model to generate a plurality of output model-generated images (e.g., synthetic images that include predicted pixel data) that include the particular object in one or more environments. The one or more environments of the plurality of output model-generated images can differ from the one or more background environments of the one or more input images. One or more particular output model-generated images of the plurality of output model-generated images may be selected for output based on an object metric that measures the similarity between the object of the input images and the rendered object in the respective output model-generated image. Additionally and/or alternatively, one or more particular output model-generated images of the plurality of output model-generated images may be selected for output based on a realism metric that can be descriptive of a determined realism of a respective output model-generated image of the plurality of output model-generated images.

Additionally and/or alternatively, parameters of the image generation model and/or separate parameters may be tuned (e.g., adjusted) based on the one or more input images to train the system to render that particular object. The tuning can be based on a loss function that compares an output model-generated image against one or more input images. One or more of the plurality of output model-generated images may be obtained and provided to a user computing system in response to receiving a search query that is determined to be associated with the particular object. Alternatively and/or additionally, one or more of the plurality of output model-generated images may be obtained and provided to a user computing system in response to receiving content data that is determined to be associated with the particular object. The content data can be descriptive of one or more content items accessed by the user computing system. The input images may include multiple sets of images associated with multiple objects to be rendered. In response to processing the multiple sets of images, the multiple objects may be rendered together in the output model-generated images. The image generation model (e.g., a text-to-image generative model and/or image-to-image generative model) can include a diffusion model and/or a token-based transformer model.

In some implementations, a plurality of input images descriptive of an object can be obtained. A pre-trained image generation model can be obtained. A set of parameters can then be adjusted based on the plurality of input images and synthetic image data generated with the pre-trained image generation model. The set of parameters and the pre-trained image generation model can then be utilized to generate a plurality of model-generated images. The set of parameters can be different from a plurality of pre-tuned parameters of the pre-trained image generation model. Adjusting the set of parameters can be based on a loss function that compares an output model-generated image against one or more input images. The adjustment of the parameters can be based on training output images that are generated based on a prompt being processed with the pre-trained image generation model and the set of parameters. The plurality of input images can depict the object from different perspectives.

Additionally and/or alternatively, the plurality of input images can depict the object in different environments.

Additionally and/or alternatively, the plurality of input images descriptive of one or more particular objects can be processed with a pre-trained text-to-image generative model to generate a specialized text-to-image model and a unique identifier for the one or more particular objects. A prompt can be received and processed with the specialized text-to-image model to generate one or more model-generated images. The model-generated images can include the one or more particular objects based on the prompt including the unique identifier. The prompt can include text descriptive of a request for a particular type of environment be rendered, and the environment of the one or more model-generated images can be of the particular type of environment. The prompt may include further text conditioning (e.g., additional objects to include and/or a point of view for viewing the object). The unique identifier can include a set of characters and/or one or more embedding values.

The one or more model-generated images may include the particular object depicted in a different perspective from the one or more particular perspectives of the plurality of input images. The particular objects can include clothes, furniture, food, drinks, vehicles, and/or other objects. The system may be merchant facing and/or consumer facing. Alternatively and/or additionally, the model-generated images may be automatically generated.

Large text-to-image models can enable high-quality and diverse synthesis of images from a given text prompt. However, the models can lack the ability to mimic the appearance of subjects in a given reference set and synthesize novel renditions of them in different contexts. The systems and methods disclosed herein can provide for “personalization” of text-to-image diffusion models (e.g., specializing the model to a user request). When provided with a few images of a subject (e.g., a subject in the images, which may include an object depicted in the image set), the system can fine-tune a pretrained text-to-image model (e.g., a diffusion model based image generation model) such that the pretrained text-to-image model learns to bind a unique identifier with that specific subject (e.g., a model-readable token generated to be associated with rendering the particular subject (e.g., particular topic)). Once the subject (e.g., the object) is embedded in the output domain of the model, the unique identifier can then be used to synthesize fully-novel photorealistic images of the subject contextualized in different scenes (e.g., the object can be rendered into different settings that may include different locations with different background features). By leveraging the semantic prior embedded in the model with an autogenous class-specific prior preservation loss, the system can synthesize the subject (e.g., an object) in diverse scenes, poses, views, and/or lighting conditions that do not appear in the reference images. The systems and methods can be leveraged for subject recontextualization, text-guided view synthesis, appearance modification (e.g., property modification, which may include changing the color, texture, shape, and/or other appearance features of the subject), and artistic rendering (e.g., rendering the subject in the artistic style of a particular genre or era all while preserving the subject's key features).

Large text-to-image models can perform well on large scale and large variety image generation based on sequence-to-sequence predictions; however, particular object instance rendering can experience difficulty (e.g., the models can struggle with realistic renderings of fine-grained details associated with particular products, such as features that differentiate that particular object from other objects in that object class). The systems and methods disclosed herein can fine-tune a pre-trained text-to-image model on a set of input images of an object to (1) fine-tune the model for photorealistic renderings of that particular object and (2) embed within the model an association between object rendering of that particular object and a particular unique identifier. The association can be leveraged such that when the image generation model (e.g., the text-to-image model) processes the unique identifier the set of fine-tuned parameters are utilized to perform the object rendering.

During the fine-tuning the set of parameters may be tuned as the remaining parameters of the image generation model are fixed (or frozen) in order to not reduce the generative capabilities of the image generation model with regards to other feature renderings. Moreover, in some implementations, the unique identifier can include a control token (e.g., a model-readable token) that can condition the image generation model to perform object rendering based on the embedded semantic prior (e.g., the semantic prior embedded during fine-tuning). The use of the unique identifier can provide for higher quality renderings of the particular object, while still being able to leverage the environment rendering capabilities of the pre-trained text-to-image model.

In some implementations, the set of parameters may be trained to learn a three-dimensional representation of the particular object (e.g., via neural radiance field tuning). The set of parameters of the image generation model can be tuned to process a three-dimensional position and a two-dimensional view direction relative to a requested object rendering position to generate a plurality of color predictions and a plurality of opacity predictions associated with rendering the object. The image generation model may then leverage the plurality of color predictions and the plurality of opacity predictions to render the object within one or more environments.

The systems and methods of the present disclosure provide a number of technical effects and benefits. As one example, the systems and methods can provide an image generation system for showcasing an object with different environments and/or objects without the cost and time that is required for traditional photography shoots. The objects can be accurately and realistically rendered in scenes that may not be readily accessible to an individual attempting to generate the object showcase. The image generation can be utilized for product displays, vision boards, art, etc.

Another technical benefit of the systems and methods of the present disclosure is the ability to leverage one or more pre-trained generative models to generate imagery including backgrounds, object ensembles, and showcases that can inspire lifestyle aspirations and aesthetics. The use of pre-trained generative models can reduce the computational resource cost of training new models, which can save time and resources.

Another example of technical effect and benefit relates to improved computational efficiency and improvements in the functioning of a computing system. For example, the systems and methods disclosed herein can leverage fixed parameter tuning to limit the parameters adjusted for object-specific parameter tuning. In particular, the systems and methods disclosed herein can add new parameters and/or only adjust a set number of parameters of the pre-trained generative model when parameter tuning for accurate object rendering. The parameter tuning can include adjusting one or more parameters of the generative model to accurately and realistically render the particular object. The parameter tuning may be limited to a set of parameters to avoid affecting the quality of other renderings and to reduce the computational cost of retraining the entire model.

Another example technical effect and benefit relates to improved computational efficiency and improvements in the functioning of a computing system. For example, a technical benefit of the systems and methods of the present disclosure is the ability to reduce the computational resources needed for training and/or tuning a generative model for generating high quality outputs for particular object generation. In particular, the generative model (e.g., an image generation model) can be utilized to generate model-generated images with a plurality of predicted pixels. In some implementations, the generative model and/or one or more soft prompts (e.g., a set of machine-learned parameters that can be processed with the input by the generative model) can be trained and/or tuned for particular object generation (e.g., image pixel prediction for a particular object).

With reference now to the Figures, example embodiments of the present disclosure will be discussed in further detail.

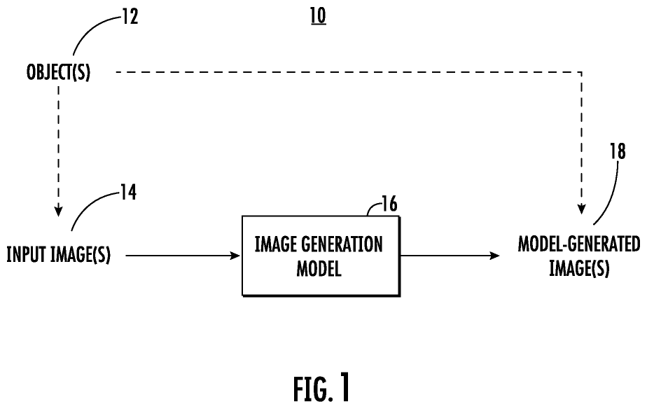

FIG. 1 depicts a block diagram of an example image generation system 10 according to example embodiments of the present disclosure. In some implementations, the example image generation system 10 is configured to receive, and/or obtain, one or more images 14 descriptive of one or more objects 12 in one or more environments and, as a result of receipt of the one or more input images 14, generate, determine, and/or provide one or more model-generated images 18 that depict the one or more objects 12 in one or more rendered environments that may differ from the one or more input environments. Thus, in some implementations, the example image generation system 10 can include an image generation model 14 (e.g., a generative image model) that is operable to generate synthetic images that depict the object in different environments, which may include different locations and/or different ensembles.

In particular, the image generation system 10 can obtain one or more input images 14 (e.g., three to five images) associated with one or more objects 12 (e.g., the images may depict a particular object from one or more angles). The one or more input images 14 may be from different times, depict different locations, and/or may have different resolutions and/or qualities. In some implementations, the one or more objects 12 can include a clothing item, a toy, an electronic device, an individual, a furniture item, a vehicle, a building, and/or another item.

The one or more input images 14 can be processed with an image generation model 16 to generate one or more model-generated images 18. Processing the one or more input images 14 can include conditioning the image generation model 16 with the one or more input images 14 to generate the one or more objects 12 (e.g., adjusting one or more parameters of the image generation model 16 based on the one or more input images 14). The image generation model 16 can include a transformer model. In some implementations, the image generation model 16 can include a diffusion model and/or a token-based transformer model. The image generation model 16 may be a pre-trained generative model.

The one or more model-generated images 18 can include synthetic images that include predicted pixel data. The one or more model-generated images 18 can depict the one or more objects 12 in one or more environments. The one or more objects 12 can be depicted in different lighting, in different environments, from different angles, and/or different poses than depicted in the one or more input images 14. In some implementations, the input data may include an input video. Additionally and/or alternatively, the output data can include one or more model-generated videos.

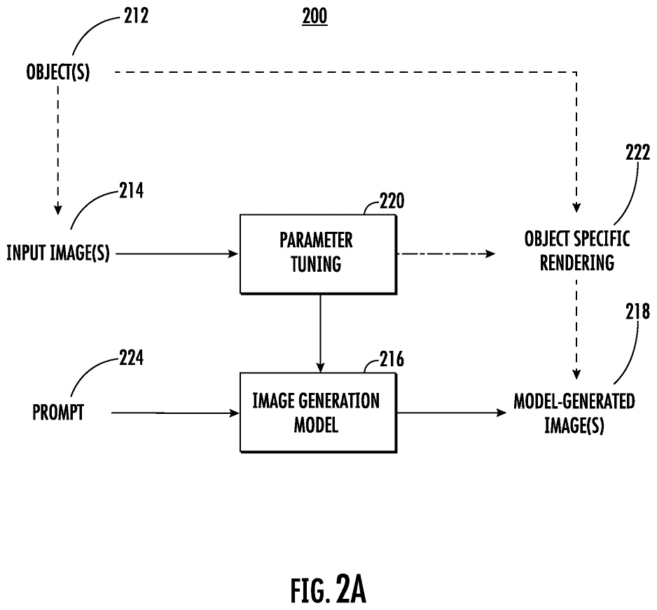

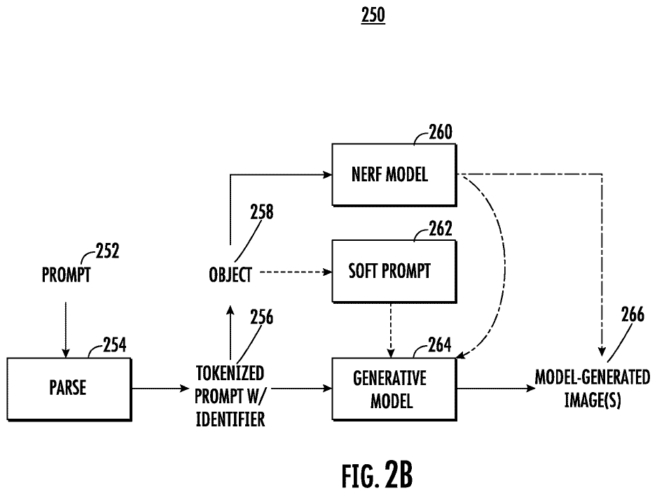

FIG. 2A depicts a block diagram of an example object-specific image generation system 200 according to example embodiments of the present disclosure. The object-specific image generation system 200 is similar to example image generation system 10 of FIG. 1 except that object-specific image generation system 200 further includes parameter tuning 220. In particular, the object-specific image generation system 200 can obtain one or more input images 214 (e.g., three to five images) associated with one or more objects 212 (e.g., the images may depict a particular object from one or more angles). The one or more input images 214 may be from different times, depict different locations, and/or may have different resolutions and/or qualities. In some implementations, the one or more objects 212 can include a clothing item, a toy, an electronic device, an individual, a furniture item, a vehicle, a building, and/or another item.

The one or more input images 214 can be utilized for parameter tuning 220. In particular, one or more parameters can be tuned (e.g., adjusted) based on the one or more input images 214. The parameter tuning 220 can be performed to train the image generation model 216 for object specific rendering 222 (e.g., to increase the accuracy and/or realism for rendering the one or more objects 212).

The tuned image generation model 216 can then be utilized to generate one or more model-generated images 218 depicting the one or more objects 212 in one or more environments. The tuned image generation model 216 may include additional parameters and/or adjusted parameters from an obtained pre-trained image generation model.

A prompt 224 can then be obtained. The prompt 224 can include text data, image data, latent encoding data, statistical data, audio data, multimodal data, and/or other data. The prompt 224 may be descriptive of a request to render the object with a particular environment, which may include a particular location, a particular lighting, and/or particular additional objects. In some implementations, the prompt 224 may include a unique identifier that instructs the image generation model to render the one or more objects 212.

The prompt 224 can be processed with the image generation model 216 to generate one or more model-generated images 218. The image generation model 216 can include a transformer model. In some implementations, the image generation model 216 can include a diffusion model and/or a token-based transformer model. The image generation model 216 may be a pre-trained generative model.

The one or more model-generated images 218 can include synthetic images that include predicted pixel data. The one or more model-generated images 218 can depict the one or more objects 212 in one or more environments. The one or more objects 212 can be depicted in different lighting, in different environments, from different angles, and/or different poses than depicted in the one or more input images 214. In some implementations, the one or more model-generated images 218 can include one or more features generated based on the prompt 224. For example, a particular additional object and/or a particular scene may be rendered based on the prompt 224. The input data may include an input video.

Additionally and/or alternatively, the output data can include one or more model-generated videos.

FIG. 2B depicts a block diagram of an example foreground-background image generation system 250 according to example embodiments of the present disclosure. In particular, the image generation system 250 can include obtaining a prompt 252 and processing the prompt 252 to generate one or more model-generated images 266.

For example, the image generation system 250 can obtain a prompt 252 from a user. The prompt 252 can include text data, image data, audio data, latent encoding data, and/or multimodal data. The prompt 252 may include a text string descriptive of a requested image rendering of a particular object 258 in one or more environments. In some implementations, the prompt 252 may include a request for multiple objects (e.g., a particular vase, a particular table, and a particular chair rendered within a living room) to be rendered in one or more environments.

The prompt 252 can then be parsed via one or more parse blocks 254, which may include one or more classifiers and/or one or more natural language processing models. The prompt 252 can be processed with the one or more parse blocks 254 to identify and/or separate one or more terms and/or one or more identifiers associated with the particular object 258. In particular, the one or more parse blocks 254 can be leveraged to determine the particular portion of the prompt 252 that is descriptive of the particular object 258. The particular portion of the prompt 252 may then be replaced with a unique object identifier to generate a tokenized prompt 256. The unique object identifier may include a control token associated with the particular object 258. The control token can be configured, trained, and/or tuned to condition the generative model 264 for object-specific image rendering.

Alternatively and/or additionally, the unique identifier may be utilized to perform a call (e.g., an application programming interface call) and/or retrieval to obtain an object-specific neural radiance field model 260 and/or an object-specific soft prompt 262. The object-specific neural radiance field model 260 and/or the object-specific soft prompt 262 may have been trained and/or tuned on a set of images of the particular object 258. The training may be performed separately and/or with the generative model 264.

The image generation system 250 can then leverage the object-specific neural radiance field model 260 for object view synthesis rendering, while the generative model 264 performs the pixel prediction for the remainder of the image rendering. For example, the generative model 264 may process the tokenized prompt 256 and an object rendering generated with the object-specific neural radiance field model 260 in order to generate one or more model-generated images 266 that include a realistic rendering of the object 258, while also including predicted pixels descriptive of features requested via the remaining portions of the prompt 252.

Alternatively and/or additionally, the tokenized prompt 256 and the object-specific soft prompt 262 may be processed with the generative model 264 to generate the one or more model-generated images 266. For example, the object-specific soft prompt 262 may include a set of model-readable weights (and/or parameters) that can condition the generative model 264 for photo-realistic renderings of the particular object 258.

In some implementations, the generative model 264 may be tuned for object-specific image rendering. The generative model 264 may be tuned based on real world images of the object and/or may be tuned on view synthesis renderings generated with the object-specific neural radiance field model 260. The fine-tuned model may then be stored.

The stored model can then be retrieved whenever the object identifier is detected.

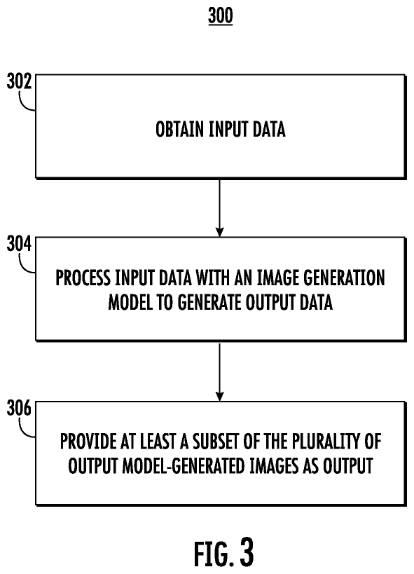

FIG. 3 depicts a flow chart diagram of an example method to perform according to example embodiments of the present disclosure. Although FIG. 3 depicts steps performed in a particular order for purposes of illustration and discussion, the methods of the present disclosure are not limited to the particularly illustrated order or arrangement. The various steps of the method 300 can be omitted, rearranged, combined, and/or adapted in various ways without deviating from the scope of the present disclosure.

At 302, a computing system can obtain input data. The input data can include one or more input images. In some implementations, the one or more input images can be descriptive of a particular object. The input data may include a plurality of input images depicting the particular object in different positions, angles, lighting, and/or locations. The particular object may include an article of clothing, a furniture item, an accessory, an individual, a vehicle, a plant, a food item, a drink, and/or another type of object.

At 304, the computing system can process the input data with an image generation model to generate output data. The image generation model may have been trained to generate a set of model-generated images based on an input. The output data can include a plurality of output model-generated images. In some implementations, the plurality of output model-generated images can be descriptive of the particular object in one or more environments. Additionally and/or alternatively, the one or more environments may differ from one or more background environments of the one or more input images. The image generation model can include at least one of a diffusion model or a token-based transformer model. The image generation model may include a plurality of multi-layer perceptron blocks to perform color prediction and density prediction for object rendering.

In some implementations, processing input data with the image generation model to generate the output data can include tuning a set of parameters based on the one or more input images. The image generation model can include the set of parameters. Additionally and/or alternatively, processing input data with the image generation model to generate the output data can include generating the plurality of output model-generated images based at least in part on the set of parameters tuned based on the one or more input images. Tuning the set of parameters can include generating a first model-generated image with the image generation model, evaluating a loss function that evaluates a difference between the first model-generated image and the one or more input images, and adjusting one or more parameters of the set of parameters based at least in part on the loss function. In some implementations, processing input data with the image generation model to generate the output data can include embedding an association between a model-readable token and the set of parameters within the image generation model and generating a plurality of prompts that include the model-readable token. The object can then be rendered based on the set of parameters upon the image generation model recognizing the model-readable token. The model-readable token can be a unique identifier generated to be associated with the particular object (e.g., a particular model of shoe, a particular model and year of a car, a particular toy, etc.).

In some implementations, the image generation model may determine one or more particular environments and/or a particular environment type that is to be rendered based on a determined object type, a determined object quality, and/or a determined object use.

At 306, the computing system can provide at least a subset of the plurality of output model-generated images as output. The input data can include a first set of input images associated with a first object and a second set of images associated with a second object. The plurality of output model-generated images can be descriptive of the first object and the second object in the one or more environments.

In some implementations, the computing system can process the plurality of output model-generated images and the one or more input images to determine an object metric for each of the plurality of output model-generated images. The object metric can be descriptive of a determined similarity between the particular object as depicted in the one or more input images and the particular object as depicted in a respective output model-generated image of the plurality of output model-generated images. The computing system may determine the subset of the plurality of output model-generated images to output based on the plurality of object metrics.

Additionally and/or alternatively, the computing system can process the plurality of output model-generated images to determine a realism metric for each of the plurality of output model-generated images. The realism metric can be descriptive of a determined realism of a respective output model-generated image of the plurality of output model-generated images. The computing system may determine the subset of the plurality of output model-generated images to output based on the plurality of realism metrics.

In some implementations, the computing system can obtain a search query. The computing system may determine the search query is associated with the particular object and provide one or more output model-generated images of the plurality of output model-generated images for display in a search results interface based on the search query being associated with the particular object.

Alternatively and/or additionally, the computing system can obtain content data from a user computing system. The content data can be descriptive of one or more content items accessed by the user computing system. The computing system can determine the content data is associated with the particular object and provide one or more output model-generated images of the plurality of output model-generated images to the user computing system based on the content data being associated with the particular object.

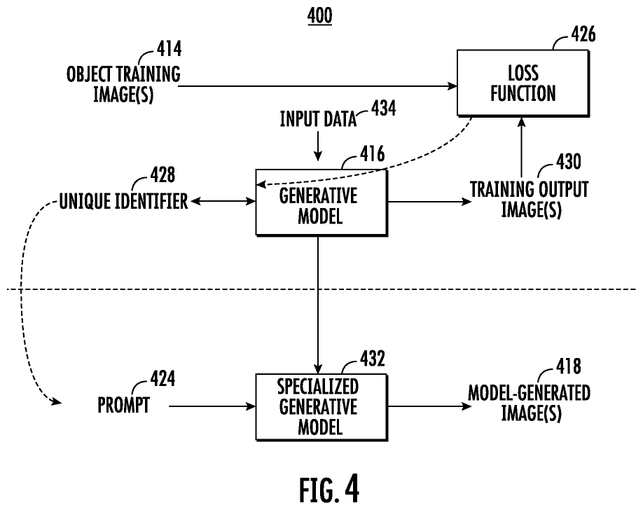

FIG. 4 depicts a block diagram of an example specialized generative model generation and inference system 400 according to example embodiments of the present disclosure. In particular, the specialized generative model generation and inference system 400 can include training a generative model 416 for object specific rendering.

For example, input data 434 (e.g., a text prompt (e.g., an object name or description) and/or a unique identifier 428) can be obtained and processed with a generative model 416 (e.g., a pre-trained generative image model) to generate one or more training output images 430 (e.g., one or more model-generated images).

The one or more training output images 430 can then be utilized to evaluate a loss function 426 to generate a gradient descent. The gradient descent can then be backpropagated to the generative model 416 to adjust one or more parameters to generate a specialized generative model 432 (e.g., a generative image model specialized to render a specific object. Evaluating the loss function 426 can include comparing the one or more training output images 430 to one or more ground truth object training images 414 (e.g., one or more real world images of the object). In some implementations, the generative model 416 may output a unique identifier 428 associated with the object.

The training can be performed iteratively until a quality threshold is obtained. In some implementations, the loss function 426 can include a realism loss term for penalizing image features determined to be unrealistic. Additionally and/or alternatively, the loss function 426 may include an object accuracy term that incentivizes the generative model 416 to generate object renderings similar to the object depictions in the object training images 414.

The generated specialized generative model 432 can then be utilized to generate showcase images. For example, a prompt 424 can be obtained and processed with the specialized generative model 432 to generate one or more model-generated images 418.

The prompt 424 may include text data, image data, audio data, latent encoding data, multimodal data, and/or other data. The prompt 424 may include the unique identifier 428, which instructs the specialized generative model 432 to render the object. In some implementations, the prompt 424 can include the unique identifier and text descriptive of a requested environment to render the object in for the model-generated images 418.

The specialized generative model 432 may generate one or more model-generated images 418 that are responsive to the prompt 424. In some implementations, the prompt 424 may be automatically generated based on one or more user interface selections and/or based on a user query.

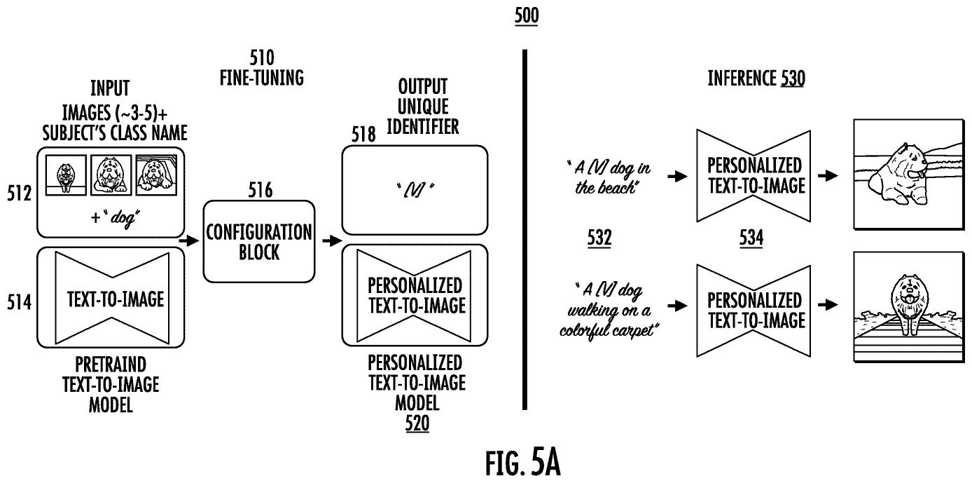

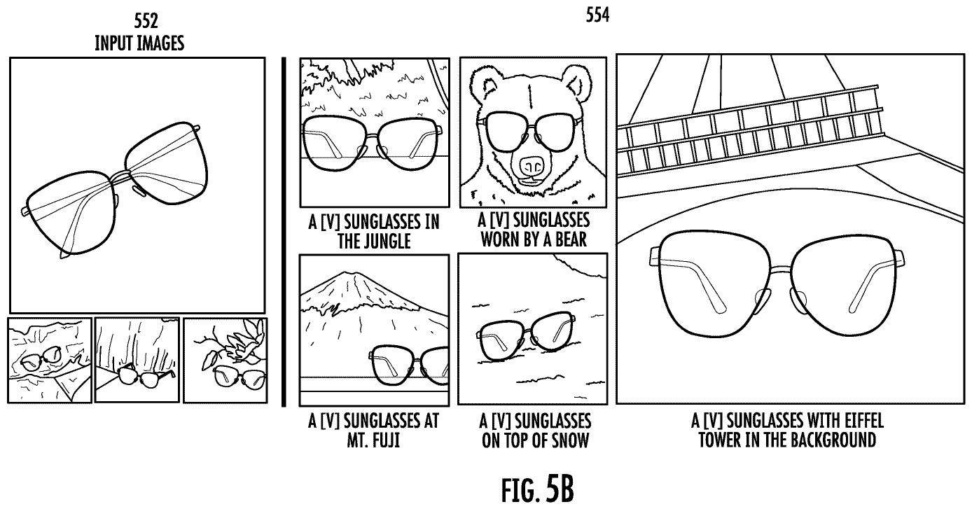

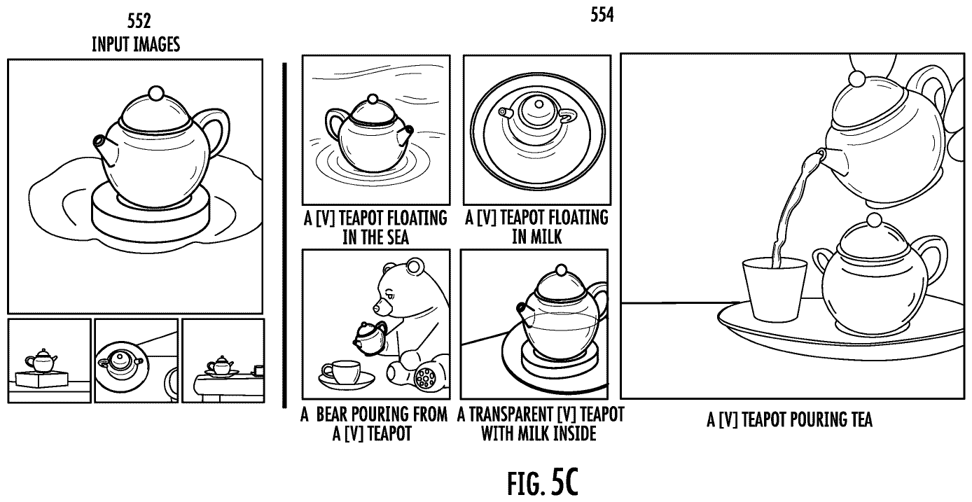

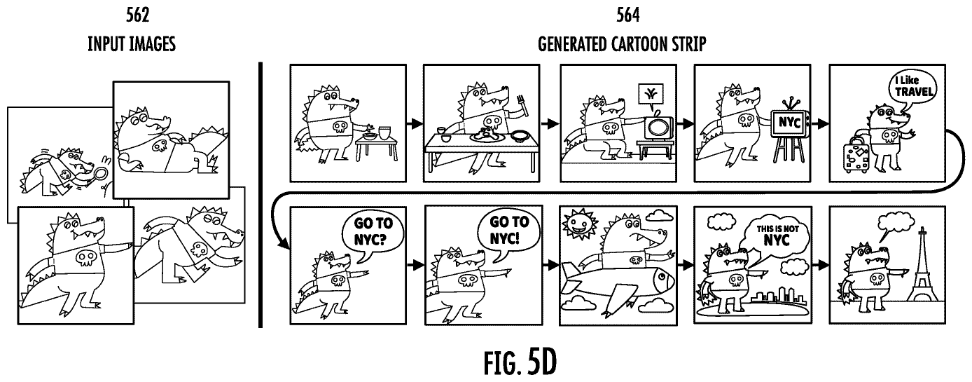

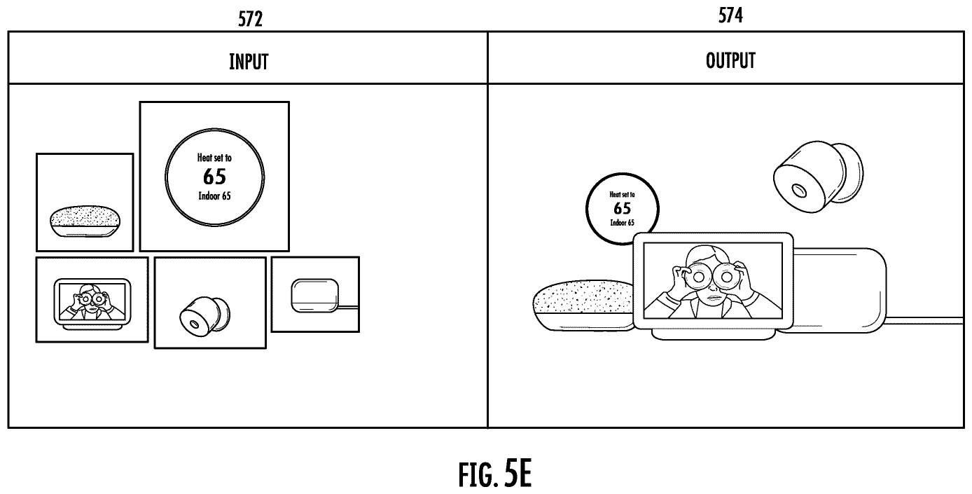

FIG. 5A depicts a block diagram of an example model tuning and inference system 500 according to example embodiments of the present disclosure.

In particular, the model tuning and inference system 500 can include object-conditioned generative models. Large generative models (e.g., Imagen, Parti, DALLE-2, MaskGIT) can generate images with high levels of photorealism and semantic coherence.

However, the large generative models may lack the ability to incorporate a certain object, which is a crucial requirement for our use case. The model tuning and inference system 500 can adapt these models to be able to condition the generations on object appearances.

In addition to object appearances, the model tuning and inference system 500 can condition the models on textual/personalization signals. For example, if the featured product is a couch, and the system may determine that the user might desire modern, minimalist aesthetics. Therefore, the model tuning and inference system 500 may generate a shopping ad with the couch placed seamlessly into a modern, minimalist living room.

The model tuning and inference system 500 may implement an approach to fine-tune a pretrained text-to-image model (e.g., Imagen) on a small set (e.g., three to five) of input images that include the object of interest, such that the generative model learns to bind a unique identifier with that specific object. Once the unique identifier is associated with the object through the fine-tuning, the model tuning and inference system 500 can be used to synthesize fully-novel photorealistic images of the object, contextualized in different scenes. By leveraging the semantic prior embedded in the model with a new autogenous class-specific prior preservation loss, the model tuning and inference system 500 can enable the synthesis of the specific object in diverse scenes, poses, views, and lighting conditions that are fully novel.

In some implementations, the model tuning and inference system 500 can obtain as input a few images (e.g., three to five images) of a subject/object (e.g., a specific dog) and the corresponding class name (e.g. “dog”), and return a fine-tuned/“personalized” text-to-image model that encodes a unique identifier that refers to the subject. Then, at inference time, the model tuning and inference system 500 can implant the unique identifier in different sentences to synthesize the subjects in different contexts.

The model tuning and inference system 500 can obtain as input a few images 512 (e.g., three to five images) of a subject/object (e.g., a specific dog) and the corresponding class name (e.g. “dog”), and can return a fine-tuned/“personalized” text-to-image model 520 that encodes a unique identifier 518 that refers to the subject. Then, at inference time, the model tuning and inference system 500 can implant the unique identifier 518 in different sentences 532 to synthesize the subjects in different contexts 536.

More specifically, the model tuning and inference system 500 can include a fine-tuning 510 process that includes obtaining a training dataset (e.g., training images 512 depicting an object and a corresponding name for the object) and a pre-trained text-to-image model 514. The training dataset and the pre-trained text-to-image model 514 can be processed with a configuration block 516 that tunes a set of parameters based on the training dataset to generate a personalized (or specialized) text-to-image model 520 (specialized to generate the object) and a unique identifier 518 associated with the object.

Once fine-tuning 510 is completed, inference 530 can be performed. In particular, a prompt (e.g., an automatically generated sentence 532 with the unique identifier 518 and/or a user input prompt) with the unique identifier 518 can be processed with the personalized (or specialized) text-to-image model 534 to generate one or more model-generated images that depict the object (e.g., the dog) in different contexts 536.

The fine-tuning 510 and inference 530 process may be performed for one object and/or a plurality of objects. The prompts can be automatically generated, user guided, and/or freeform prompt inputs by the user.

FIGS. 5B and 5C depict example inputs and outputs for object-specific tuning and model-generated image generation. For example, the image generation model can be trained on a set of input images 552 that depict the particular object. The set of input images 552 can be leveraged to tune and/or train the model to generate renderings of the particular object. The tuned and/or trained image generation model can then process prompts with the object identifier and generate one or more model-generated outputs images 554. The one or more model-generated output images 554 can be descriptive of the particular object rendered into an environment described by the remaining portion of the prompt.

In particular, FIG. 5B depicts illustrations of example inputs and outputs that include a particular pair of sunglasses according to example embodiments of the present disclosure. In FIG. 5B, the set of input images 552 depict a particular pair of sunglasses.

The image generation model can be tuned and/or trained to render photo-realistic renderings of that particular pair of glasses when the unique object identifier is provided. The unique object identifier may include an embedding, a set of tuned weights, a token, and/or other data. The tuned and/or trained model can then be leveraged to generate model-generated output images 554 of the particular sunglasses on different users, on different surfaces, and/or in different settings.

FIG. 5C depicts illustrations of example inputs and outputs that include a particular teapot according to example embodiments of the present disclosure. In FIG. 5C, the set of input images 552 depict a particular teapot with a particular style, color, and size.

The image generation model can be tuned and/or trained to render photo-realistic renderings of that particular teapot when the unique object identifier is provided. The unique object identifier may include an embedding, a set of tuned weights, a token, and/or other data. The tuned and/or trained model can then be leveraged to generate model-generated output images 554 of the particular teapot on different surfaces, in different art forms, in different lighting, and/or in different settings.

FIG. 5D depicts illustrations of example inputs and outputs for comic strip generation according to example embodiments of the present disclosure. In particular, in some implementations, the systems and methods disclosed herein can be leveraged to train an image generation model on a particular character, individual, and/or setting and then generate a comic strip that includes uniform rendering of the character performing different actions, in different places, and/or with different surroundings. For example, the image generation model can be tuned and/or trained on a set of input images 562 of the particular character. The trained and/or tuned image generation model can then generate a model-generated comic strip 564 based on the character, a model-generated script, and/or an input prompt.

FIG. 5E depicts illustrations of example inputs and outputs for multi-object rendering according to example embodiments of the present disclosure. In particular, the systems and methods disclosed herein can be leveraged to generate model-generated images that include a plurality of different objects rendered together. For example, an image generation model and/or one or more soft prompts may be tuned and/or trained on a set of input images 572. The set of input images can include a subset of images for each object of a plurality of different objects a user is requesting be rendered. The tuned and/or trained image generation model and/or one or more soft prompts can then be leveraged to generate one or more model-generated images 574 that depict the plurality of different objects in an environment together.

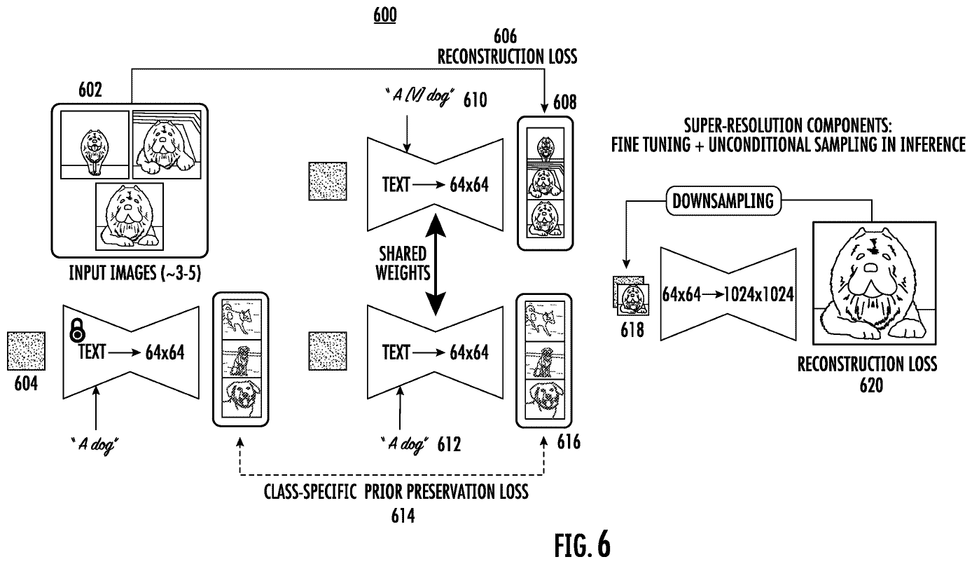

FIG. 6 depicts a block diagram of an example object specific parameter tuning system 600 according to example embodiments of the present disclosure.

The object specific parameter tuning system 600 can obtain a set of input images 602 of an object (e.g., a subject). The set of input images 602 can then be utilized to tune a text-to-image diffusion in two steps: (a) fine tuning the low-resolution text-to-image model with the input images 602 paired with a text prompt containing a unique identifier and the name of the class the subject belongs to (e.g., “A photo of a [T] dog”) 610. In parallel, object specific parameter tuning system 600 can apply a class-specific prior preservation loss 614, which leverages the semantic prior that the model has on the class and encourages the model to generate diverse instances belonging to the subject's class by injecting the class name in the text prompt (e.g., “A photo of a dog”) 612; (b) fine-tuning the super resolution components with pairs of low-resolution 618 and high-resolution images 620 taken from the input images set, which enables the object specific parameter tuning system 600 to maintain high-fidelity to small details of the subject.

For example, the object specific parameter tuning system 600 can obtain input images 602 that are utilized to train a text-to-image model to render the particular object of the input images 602 when provided a prompt with a particular unique identifier 610 by utilizing a reconstruction loss that evaluates differences between the object in the input images and the object in the output images. Additionally, the object specific parameter tuning system 600 can perform class generation stabilization. The class generation stabilization can include processing a class name prompt 612 with a fixed pretrained text-to-image model 604 to generate a first set of outputs, processing the class name prompt 612 with the text-to-image model being tuned to generate a second set of outputs, and evaluating a class-specific prior preservation loss 614 to ensure the class is preserved during tuning.

The object specific parameter tuning system 600 can include fine-tuning the super resolution components with pairs of low-resolution 618 and high-resolution images 620, which may include utilizing a reconstruction loss 606 to maintain high-fidelity to small details of the subject.

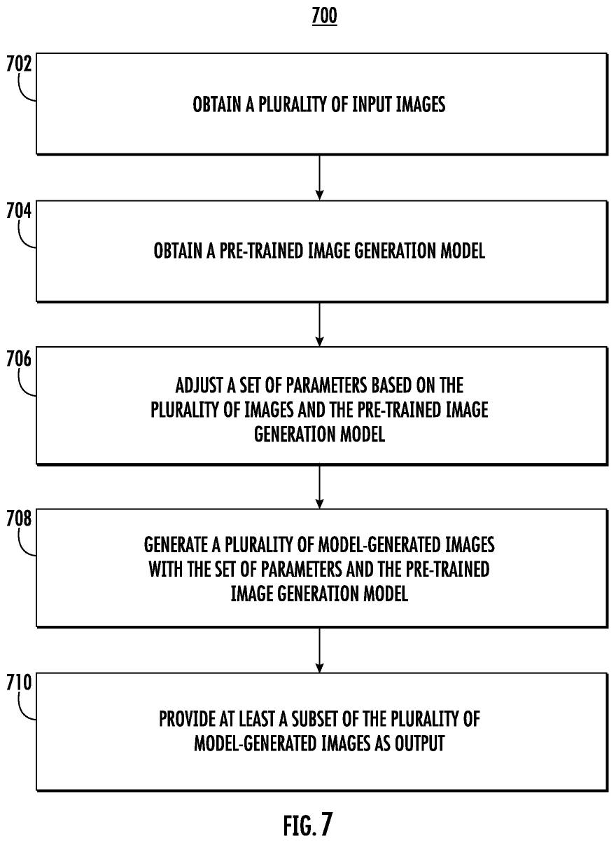

FIG. 7 depicts a flow chart diagram of an example method to perform according to example embodiments of the present disclosure. Although FIG. 7 depicts steps performed in a particular order for purposes of illustration and discussion, the methods of the present disclosure are not limited to the particularly illustrated order or arrangement. The various steps of the method 700 can be omitted, rearranged, combined, and/or adapted in various ways without deviating from the scope of the present disclosure.

At 702, a computing system can obtain a plurality of input images. Each of the plurality of input images can depict the object. The plurality of input images may depict the object from different perspectives. wherein the plurality of input images depict the object in different environments.

At 704, the computing system can obtain a pre-trained image generation model. The pre-trained image generation model may have been trained to process an input and generate an output image that comprises predicted pixels.

At 706, the computing system can adjust a set of parameters based on the plurality of images and the pre-trained image generation model. The set of parameters can be different from a plurality of pre-tuned parameters of the pre-trained image generation model.

In some implementations adjusting the set of parameters based on the plurality of images and the pre-trained image generation model can include generating a plurality of training output images with the pre-trained image generation model and the set of parameters, evaluating a loss function that evaluates a difference between one or more respective training output images of the plurality of training output images and one or more of the plurality of input images, and adjusting one or more parameters of the set of parameters based at least in part on the loss function.

Additionally and/or alternatively, generating the plurality of training output images with the pre-trained image generation model and the set of parameters can include obtaining a prompt associated with the object and processing the prompt with the pre-trained image generation model and the set of parameters to generate the plurality of training output images. The prompt can include text data and the unique identifier. The object can be rendered based on the set of parameters in response to the pre-trained image generation model processing the unique identifier.

At 708, the computing system can generate a plurality of model-generated images with the set of parameters and the pre-trained image generation model. The plurality of model-generated images can include predicted image data that depicts the object in one or more environments.

In some implementations, the computing system can associate the set of parameters with a unique identifier. The association can be associated with a control token association such that the image generation model leverages the set of parameters for object rendering upon receiving the unique identifier. The computing system can then generate a plurality of prompts that include the unique identifier and a plurality of different terms associated with a plurality of different settings (e.g., a store, a beach, a car, and/or other locations or environments). The plurality of model-generated images can then be generated based on processing the plurality of prompts with the pre-trained image generation model and the set of parameters. The object can be rendered based on the set of parameters (in response to processing the unique identifier), while the one or more environments are rendered based on the plurality of different terms associated with a plurality of different settings.

At 710, the computing system can provide at least a subset of the plurality of model-generated images as output. The subset may be determined based on one or more determinations, which may include a realism determination, an object accuracy determination, a relevance determination, a user preference, and/or a user-specific determination.

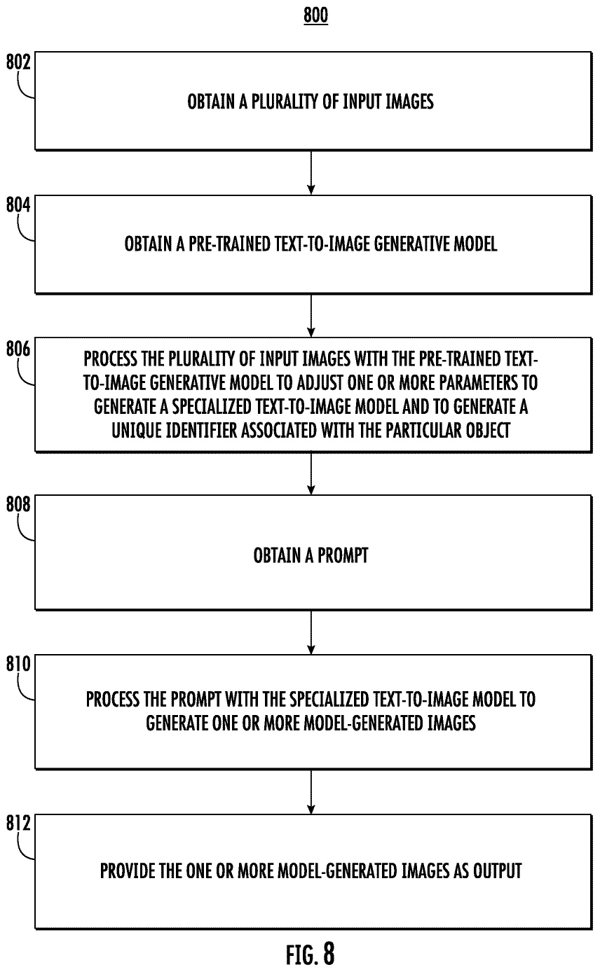

FIG. 8 depicts a flow chart diagram of an example method to perform according to example embodiments of the present disclosure. Although FIG. 8 depicts steps performed in a particular order for purposes of illustration and discussion, the methods of the present disclosure are not limited to the particularly illustrated order or arrangement. The various steps of the method 800 can be omitted, rearranged, combined, and/or adapted in various ways without deviating from the scope of the present disclosure.

At 802, a computing system can obtain a plurality of input images. The plurality of input images can be descriptive of a particular object. The particular object can include a product. In some implementations, the particular object can include a clothing item, a furniture item, make-up, electronics, vehicles, plants, food, drinks, a person, a building, and/or another object.

At 804, the computing system can obtain a pre-trained text-to-image generative model. The pre-trained text-to-image generative model may have been trained to process an input and generate an output image that includes predicted pixels.

At 806, the computing system can process the plurality of input images with the pre-trained text-to-image generative model to adjust one or more parameters to generate a specialized text-to-image model and to generate a unique identifier associated with the particular object. The specialized text-to-image model can be trained to generate image data associated with the particular object in response to processing the unique identifier. In some implementations, the unique identifier can include at least one of a set of characters or one or more embedding values.

At 808, the computing system can obtain a prompt. The prompt can include text data and the unique identifier. The text data can include text descriptive of a request for a particular environment to be rendered with the object. The prompt may include one or more desired parameters for rendering (e.g., a lighting value and/or range). In some implementations, the prompt may be descriptive of a requested point of view and/or a requested ensemble.

At 810, the computing system can process the prompt with the specialized text-to-image model to generate one or more model-generated images. The one or more model-generated images can include the particular object in an environment. The environment can be generated based at least in part on the text data. In some implementations, the text data can be descriptive of a request for a particular type of environment to be rendered. The environment of the one or more model-generated images can be of the particular type of environment. The one or more model-generated images may include the particular object depicted in a different perspective from the one or more particular perspectives of the plurality of input images.

At 812, the computing system can provide the one or more model-generated images as output. The one or more model-generated images can be provided for display in a user interface. The user interface can include a search results interface, a social media interface, a generation engine interface, an advertisement interface, a carousel interface, a video player interface, and/or another type of interface.

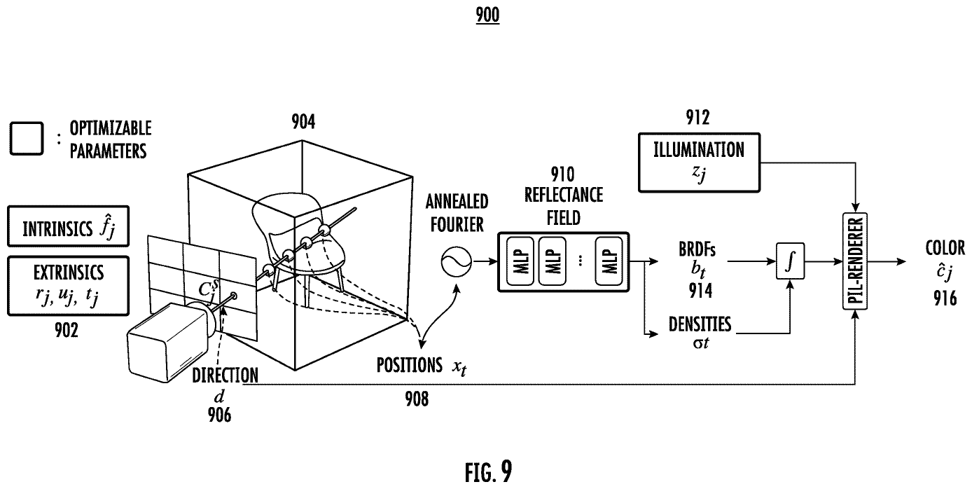

FIG. 9 depicts a block diagram of an example object understanding system 900 according to example embodiments of the present disclosure. In particular, the object understanding system 900 can be utilized for three-dimensional understanding of an object. The object understanding system 900 can estimate a three-dimensional shape and material in-the-wild based on input images, which may include internet images. The object understanding system 900 can enable at-scale product shape acquisition and re-rendering without any special capturing setup. In some implementations, the object understanding system 900 can include a joint optimization framework to estimate the shape, BRDF, and/or per-image camera pose and illumination. The object understanding system 900 can jointly optimize the intrinsic and extrinsic camera parameters alongside the shape and BRDF in a Reflectance Field and per-image illumination.

For example, the object understanding system 900 can process one or more input images to optimize the intrinsic and extrinsic camera parameters 902 and/or generate a three-dimensional representation 904. The three-dimensional representation 904 can be based on and/or utilized for direction 906 estimation and position 908 estimation. The direction(s) 906 and position(s) 908 can be processed with an Annealed Fourier block (e.g., an Annealed Fourier function) and may then be processed by a plurality of multilayer perceptron blocks. The plurality of multilayer perceptron blocks may be part of a reflectance field block 910.

The outputs 914 of the reflectance field block 910 may include a bidirectional reflectance distribution function (BRDF) output (e.g., a value for the scattered radiance to surface irradiance) and/or one or more density values. The outputs 914 can then be processed with one or more blocks including a renderer block to generate one or more predicted color values 916 for output. The renderer block may additionally process one or more illumination values 912 to determine the one or more color values 916.

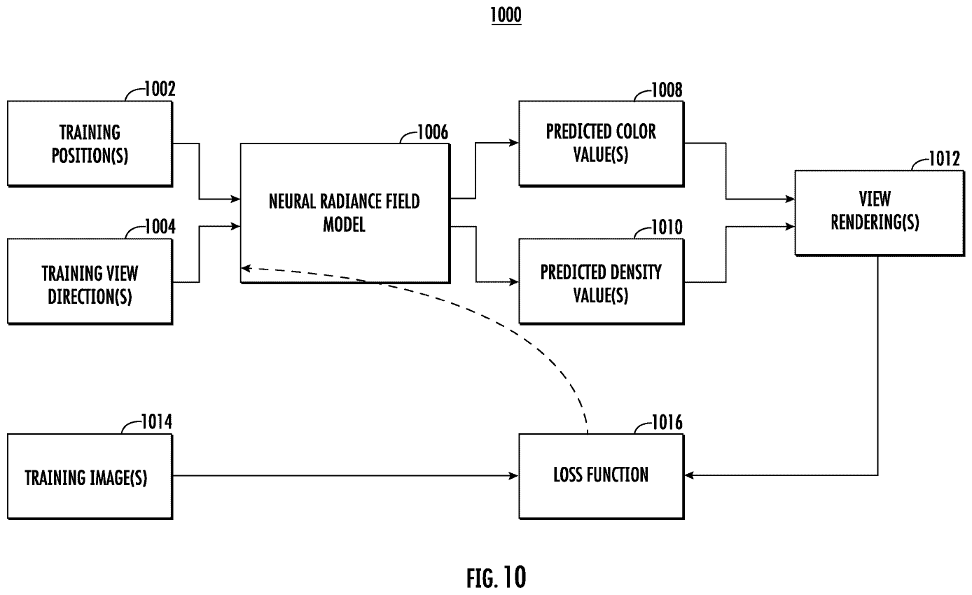

FIG. 10 depicts a block diagram of an example neural radiance field model training 1000 according to example embodiments of the present disclosure. Training the neural radiance field model 1006 can include processing one or more training datasets. The one or more training datasets can be specific to one or more objects and/or one or more environments. For example, a neural radiance field model 1006 can process a training position 1002 (e.g., a three-dimensional position) and a training view direction 1004 (e.g., a two-dimensional view direction and/or a vector) to generate one or more predicted color values 1008 and/or one or more predicted density values 1010. The one or more predicted color values 1008 and the one or more predicted density values 1010 can be utilized to generate a view rendering 1012.

A training image 1014 associated with the training position 1002 and training view direction 1004 can be obtained. The training image 1014 and the view rendering 1012 can be utilized to evaluate a loss function 1016. The evaluation can then be utilized to adjust one or more parameters of the neural radiance field model 1006. For example, the training image 1014 and the view rendering 1012 can be utilized to evaluate the loss function 1016 to generate a gradient descent, which can be backpropagated to adjust the one or more parameters. The loss function 1016 can include an L2 loss function, a perceptual loss function, a mean-squared loss function, a cross-entropy loss function, and/or a hinge loss function.

In some implementations, the systems and methods disclosed herein can be utilized to generate and/or render augmented environments based on user image data, one or more neural radiance field models, meshes, and/or suggested datasets.

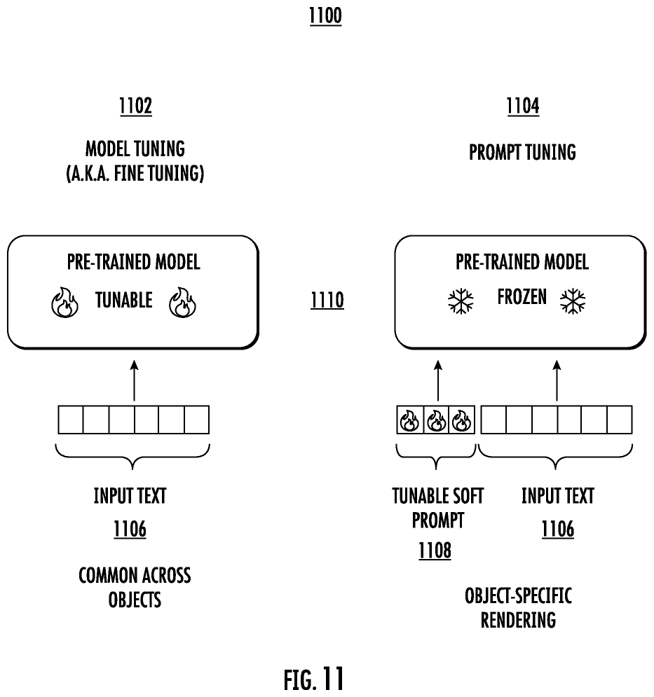

FIG. 11 depicts a block diagram of an example soft prompt tuning system 1100 according to example embodiments of the present disclosure. In particular, the systems and methods disclosed herein can include model tuning 1102 for image generation training (e.g. tuning for tasks (or attributes) associated with generating view renderings of a plurality of different objects and/or environments) and can include prompt tuning 1104 for object-specific conditioning (e.g., tuning for tasks (or attributes) specific to view renderings for a particular object and/or particular object types).

For example, model tuning 1102 can be leveraged for image rendering fine-tuning. The input text 1106 can be processed with the pre-trained model 1110 to generate an output that can then be evaluated to generate a gradient descent. One or more parameters of the pre-trained model 1110 may then be adjusted based on the gradient descent to tune the pre-trained model 1110 to generate image renderings (e.g., realistic view renderings).

The prompt tuning 1104 can be leveraged for object-specific fine-tuning (and/or object-specific conditioning). The input text 1106 and the tunable soft prompt 1108 can be processed with the pre-trained model 1110 to generate an output that can then be evaluated to generate a gradient descent. One or more parameters of the tunable soft prompt 1108 may then be adjusted based on the gradient descent. The parameters of the pre-trained model 1110 may remain unchanged (i.e., frozen). The tunable soft prompt 1108 can be fine-tuned to be processed with the input text 1106 to condition the pre-trained model 1110 to generate images with a particular object.

Prompt tuning 1104 can retain the strong task performance of model tuning 1102, while keeping the pre-trained model frozen (e.g., not adjusting parameters of the generative model, while adjusting parameters of the soft prompt), enabling efficient multitask serving. FIG. 11 can depict that although model tuning 1102 can have strong task performance, model tuning 1102 is computationally expensive and can require a newly trained model for each new task. Alternatively, engineered prompt design (e.g., the use of several canonical examples with a task description) can allow the use of a single model for multiple tasks; however, task performance can be relatively weak due to the heavy reliance on the task description and the number of examples. However, prompt tuning 1104 can utilize a single pre-trained model for a plurality of downstream tasks while maintaining strong task performance as tunable soft prompts are learned for each task in which each tunable soft prompt includes a limited number of learned parameters.

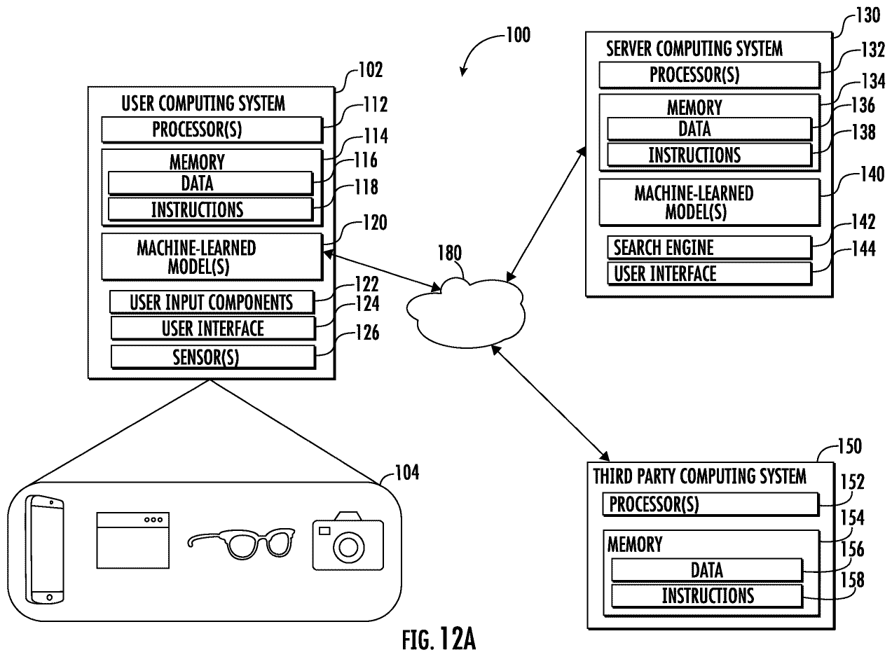

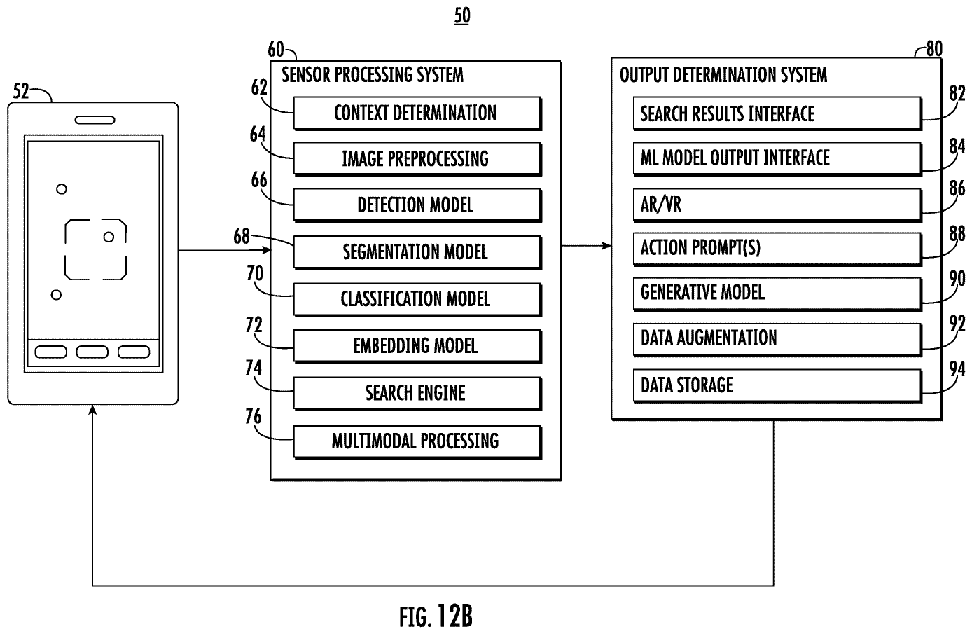

FIG. 12A depicts a block diagram of an example computing system 100 that performs model-generated image generation according to example embodiments of the present disclosure. The system 100 includes a user computing system 102, a server computing system 130, and/or a third computing system 150 that are communicatively coupled over a network 180.

The user computing system 102 can include any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing system 102 includes one or more processors 112 and a memory 114. The one or more processors 112 can be any suitable processing device (e.g., a processor core, a microprocessor, an ASIC, a FPGA, a controller, a microcontroller, etc.) and can be one processor or a plurality of processors that are operatively connected. The memory 114 can include one or more non-transitory computer-readable storage mediums, such as RAM, ROM, EEPROM, EPROM, flash memory devices, magnetic disks, etc., and combinations thereof. The memory 114 can store data 116 and instructions 118 which are executed by the processor 112 to cause the user computing system 102 to perform operations.

In some implementations, the user computing system 102 can store or include one or more machine-learned models 120. For example, the machine-learned models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks.

In some implementations, the one or more machine-learned models 120 can be received from the server computing system 130 over network 180, stored in the user computing device memory 114, and then used or otherwise implemented by the one or more processors 112. In some implementations, the user computing system 102 can implement multiple parallel instances of a single machine-learned model 120 (e.g., to perform parallel machine-learned model processing across multiple instances of input data and/or detected features).

More particularly, the one or more machine-learned models 120 may include one or more detection models, one or more classification models, one or more segmentation models, one or more augmentation models, one or more generative models, one or more natural language processing models, one or more optical character recognition models, and/or one or more other machine-learned models. The one or more machine-learned models 120 can include one or more transformer models. The one or more machine-learned models 120 may include one or more neural radiance field models, one or more diffusion models, and/or one or more autoregressive language models.

The one or more machine-learned models 120 may be utilized to detect one or more object features. The detected object features may be classified and/or embedded. The classification and/or the embedding may then be utilized to perform a search to determine one or more search results. Alternatively and/or additionally, the one or more detected features may be utilized to determine an indicator (e.g., a user interface element that indicates a detected feature) is to be provided to indicate a feature has been detected. The user may then select the indicator to cause a feature classification, embedding, and/or search to be performed. In some implementations, the classification, the embedding, and/or the searching can be performed before the indicator is selected.

In some implementations, the one or more machine-learned models 120 can process image data, text data, audio data, and/or latent encoding data to generate output data that can include image data, text data, audio data, and/or latent encoding data. The one or more machine-learned models 120 may perform optical character recognition, natural language processing, image classification, object classification, text classification, audio classification, context determination, action prediction, image correction, image augmentation, text augmentation, sentiment analysis, object detection, error detection, inpainting, video stabilization, audio correction, audio augmentation, and/or data segmentation (e.g., mask based segmentation).

Machine-learned model(s) can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) can include a single or multiple instances of the same model configured to operate on data from input(s). Machine-learned model(s) can include an ensemble of different models that can cooperatively interact to process data from input(s).

For example, machine-learned model(s) can employ a mixture-of-experts structure. See, e. g., Zhou et al., Mixture-of-Experts with Expert Choice Routing, ARXIV:2202.09368v2 (Oct. 14, 2022).

Input(s) can generally include or otherwise represent various types of data. Input(s) can include one type or many different types of data. Output(s) can be data of the same type(s) or of different types of data as compared to input(s). Output(s) can include one type or many different types of data.

Example data types for input(s) or output(s) include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs or outputs, example combinations of data types include image data and audio data, image data and natural language data, natural language data and software code data, image data and biometric data, sensor data and medical data, etc. It is to be understood that any combination of data types in an input or an output can be present.

An example input can include one or multiple data types, such as the example data types noted above. An example output can include one or multiple data types, such as the example data types noted above. The data type(s) of input can be the same as or different from the data type(s) of output. It is to be understood that the example data types noted above are provided for illustrative purposes only. Data types contemplated within the scope of the present disclosure are not limited to those examples noted above.

Additionally or alternatively, one or more machine-learned models 140 can be included in or otherwise stored and implemented by the server computing system 130 that communicates with the user computing system 102 according to a client-server relationship. For example, the machine-learned models 140 can be implemented by the server computing system 140 as a portion of a web service (e.g., a viewfinder service, a visual search service, an image processing service, an ambient computing service, and/or an overlay application service). Thus, one or more models 120 can be stored and implemented at the user computing system 102 and/or one or more models 140 can be stored and implemented at the server computing system 130.

The user computing system 102 can also include one or more user input component 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

In some implementations, the user computing system can store and/or provide one or more user interfaces 124, which may be associated with one or more applications. The one or more user interfaces 124 can be configured to receive inputs and/or provide data for display (e.g., image data, text data, audio data, one or more user interface elements, an augmented-reality experience, a virtual reality experience, and/or other data for display. The user interfaces 124 may be associated with one or more other computing systems (e.g., server computing system 130 and/or third party computing system 150). The user interfaces 124 can include a viewfinder interface, a search interface, a generative model interface, a social media interface, and/or a media content gallery interface.

The user computing system 102 may include and/or receive data from one or more sensors 126. The one or more sensors 126 may be housed in a housing component that houses the one or more processors 112, the memory 114, and/or one or more hardware components, which may store, and/or cause to perform, one or more software packets. The one or more sensors 126 can include one or more image sensors (e.g., a camera), one or more lidar sensors, one or more audio sensors (e.g., a microphone), one or more inertial sensors (e.g., inertial measurement unit), one or more biological sensors (e.g., a heart rate sensor, a pulse sensor, a retinal sensor, and/or a fingerprint sensor), one or more infrared sensors, one or more location sensors (e.g., GPS), one or more touch sensors (e.g., a conductive touch sensor and/or a mechanical touch sensor), and/or one or more other sensors. The one or more sensors can be utilized to obtain data associated with a user's environment (e.g., an image of a user's environment, a recording of the environment, and/or the location of the user).

The user computing system 102 may include, and/or be part of, a user computing device 104. The user computing device 104 may include a mobile computing device (e.g., a smartphone or tablet), a desktop computer, a laptop computer, a smart wearable, and/or a smart appliance. Additionally and/or alternatively, the user computing system may obtain from, and/or generate data with, the one or more user computing devices 104. For example, a camera of a smartphone may be utilized to capture image data descriptive of the environment, and/or an overlay application of the user computing device 104 can be utilized to track and/or process the data being provided to the user. Similarly, one or more sensors associated with a smart wearable may be utilized to obtain data about a user and/or about a user's environment (e.g., image data can be obtained with a camera housed in a user's smart glasses). Additionally and/or alternatively, the data may be obtained and uploaded from other user devices that may be specialized for data obtainment or generation.

The server computing system 130 includes one or more processors 132 and a memory 134. The one or more processors 132 can be any suitable processing device (e.g., a processor core, a microprocessor, an ASIC, a FPGA, a controller, a microcontroller, etc.) and can be one processor or a plurality of processors that are operatively connected. The memory 134 can include one or more non-transitory computer-readable storage mediums, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Example models 140 are discussed with reference to FIG. 12B.

Additionally and/or alternatively, the server computing system 130 can include and/or be communicatively connected with a search engine 142 that may be utilized to crawl one or more databases (and/or resources). The search engine 142 can process data from the user computing system 102, the server computing system 130, and/or the third party computing system 150 to determine one or more search results associated with the input data. The search engine 142 may perform term based search, label based search, Boolean based searches, image search, embedding based search (e.g., nearest neighbor search), multimodal search, and/or one or more other search techniques.

The server computing system 130 may store and/or provide one or more user interfaces 144 for obtaining input data and/or providing output data to one or more users. The one or more user interfaces 144 can include one or more user interface elements, which may include input fields, navigation tools, content chips, selectable tiles, widgets, data display carousels, dynamic animation, informational pop-ups, image augmentations, text-to-speech, speech-to-text, augmented-reality, virtual-reality, feedback loops, and/or other interface elements.

The user computing system 102 and/or the server computing system 130 can train the models 120 and/or 140 via interaction with the third party computing system 150 that is communicatively coupled over the network 180. The third party computing system 150 can be separate from the server computing system 130 or can be a portion of the server computing system 130. Alternatively and/or additionally, the third party computing system 150 may be associated with one or more web resources, one or more web platforms, one or more other users, and/or one or more contexts.

An example machine-learned model can include a generative model (e.g., a large language model, a foundation model, a vision language model, an image generation model, a text-to-image model, an audio generation model, and/or other generative models).

Training and/or tuning the machine-learned model can include obtaining a training instance. A set of training data can include a plurality of training instances divided between multiple datasets (e.g., a training dataset, a validation dataset, or testing dataset). A training instance can be labeled or unlabeled. The runtime inferences can form training instances when a model is trained using an evaluation of the model's performance on that runtime instance (e.g., online training/learning). Example data types for the training instance and various tasks associated therewith are described throughout the present disclosure.

Training and/or tuning can include processing, using one or more machine-learned models, the training instance to generate an output. The output can be directly obtained from the one or more machine-learned models or can be a downstream result of a chain of processing operations that includes an output of the one or more machine-learned models.

Training and/or tuning can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi-or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

Training and/or tuning can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Training and/or tuning can include implementing a number of generalization techniques (e.g., weight decays, dropouts, etc.) to improve the generalization capability of the models being trained.

In some implementations, the above training loop can be implemented for training a machine-learned model from an initialized state to a fully trained state (e.g., when the model exhibits a desired performance profile, such as based on accuracy, precision, recall, etc.).

In some implementations, the above training loop can be implemented for particular stages of a training procedure. For instance, in some implementations, the above training loop can be implemented for pre-training a machine-learned model. Pre-training can include, for instance, large-scale training over potentially noisy data to achieve a broad base of performance levels across a variety of tasks/data types. In some implementations, the above training loop can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). An example fine-tuning approach includes reinforcement learning. Reinforcement learning can be based on user feedback on model performance during use.

In some implementations, the computing system 100 may utilize one or more soft prompts for conditioning the one or more machine-learned models (120 and/or 140) for downstream tasks. The one or more soft prompts can include a set of tunable parameters that can be trained (or tuned) as the parameters of the one or more machine-learned models (120 and/or 140) are fixed. The one or more soft prompts 124 can be trained for a specific task and/or a specific set of tasks. Alternatively and/or additionally, the one or more soft prompts 124 may be trained to condition the one or more machine-learned models (120 and/or 140) to perform inferences for a particular individual and/or one or more entities such that the output is tailored for that particular individual and/or particular entities. The one or more soft prompts 124 can be obtained and processed with one or more inputs by the one or more machine-learned models (120 and/or 140).

The one or more soft prompts can include a set of machine-learned weights. In particular, the one or more soft prompts can include weights that were trained to condition a generative model to generate model-generated view renderings of an object and/or set of objects. For example, the one or more soft prompts can be utilized by a user to generate images of an object in different environments. The one or more soft prompts can be extended to a plurality of objects. For example, the computing system 100 may tune the set of parameters on a plurality of different images of the object to condition the generative model to generate images that include a particular image. The one or more soft prompts may include a plurality of learned vector representations that may be model-readable.

A particular soft prompt can be obtained based on a particular object and/or set of objects (e.g., objects within a particular object class). The particular soft prompt can include a set of learned parameters. The set of learned parameters can be processed with the generative model to generate the model-generated image.

The user computing system 102 and/or the server computing system 130 may store one or more soft prompts associated with the particular user. The soft prompt(s) can include a set of parameters. The user computing system 102 and/or the server computing system 130 may leverage the set of parameters of the soft prompt(s) and a machine-learned image generation model to generate a model-generated image. In some implementations, the model-generated image can be generated based on the set of parameters associated with the particular object.

The utilization of a soft prompt (i.e., a set of parameters that can be processed with a generative model for downstream task conditioning) can reduce the computational cost for parameter tuning for object-specific content generation by reducing the parameters to be tuned. The set of parameters can be limited and may be adjusted while the parameters of the pre-trained generative model stay fixed. The set of parameters of the soft prompt can be utilized to condition the pre-trained generative model (e.g., the machine-learned image generation model) for particular downstream tasks (e.g., view renderings associated with an object in one or more environments).

In some implementations, the generative language model and/or one or more soft prompts (e.g., a set of machine-learned parameters that can be processed with the input by the generative language model) can be trained to generate renderings of a particular object, environment, object type, and/or environment type.

In some implementations, the server computing system 130 can include a prompt library. The prompt library can store a plurality of prompt templates (e.g., a plurality of hard prompt templates (e.g., text prompt templates)) and/or a plurality of soft prompts. The plurality of prompt templates can include hard prompt templates (e.g., text string data) that may be combined with the user input to generate a more detailed and complete prompt for the generative model to process. The templates can include text descriptive of the request. The templates may be object-specific, user-specific, and/or content-specific. The plurality of prompt templates may include few-shot examples.

The prompt library can store a plurality of soft prompts. The plurality of soft prompts may be associated with a plurality of different objects and/or a plurality of different environments. The plurality of soft prompts can include learned parameters and/or learned weights that can be processed with the generative model to condition the generative model to generate images with particular attributes. The plurality of soft prompts may have been tuned by freezing the parameters of a pre-trained generative model, while the parameters of the soft prompt are learned based on a particular task and/or user. The plurality of soft prompts can include a plurality of different soft prompts associated with a plurality of different users and/or a plurality of different sets of users.

The third party computing system 150 can include one or more processors 152 and a memory 154. The one or more processors 152 can be any suitable processing device (e.g., a processor core, a microprocessor, an ASIC, a FPGA, a controller, a microcontroller, etc.) and can be one processor or a plurality of processors that are operatively connected. The memory 154 can include one or more non-transitory computer-readable storage mediums, such as RAM, ROM, EEPROM, EPROM, flash memory devices, magnetic disks, etc., and combinations thereof. The memory 154 can store data 156 and instructions 158 which are executed by the processor 152 to cause the third party computing system 150 to perform operations. In some implementations, the third party computing system 150 includes or is otherwise implemented by one or more server computing devices.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases.

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the present disclosure can be speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data, etc.). As another example, the machine-learned model(s) can process the speech data to generate an upscaled speech output (e.g., speech data that is higher quality than the input speech data, etc.). As another example, the machine-learned model(s) can process the speech data to generate a textual representation output (e.g., a textual representation of the input speech data, etc.). As another example, the machine-learned model(s) can process the speech data to generate a prediction output.

In some implementations, the input to the machine-learned model(s) of the present disclosure can be sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the input includes visual data and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

The user computing system may include a number of applications (e.g., applications 1 through N). Each application may include its own respective machine learning library and machine-learned model(s). For example, each application can include a machine-learned model. Example applications include a text messaging application, an email application, a dictation application, a virtual keyboard application, a browser application, etc.

Each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

In some implementations, the task can be a generative task, and the one or more machine-learned models (e.g., 120 and/or 140) can be configured to output content generated in view of one or more inputs. For instance, the inputs can be or otherwise represent data of one or more modalities that encodes context for generating additional content.

In some implementations, the task can be a text completion task. The machine-learned models can be configured to process the inputs that represent textual data and to generate the outputs that represent additional textual data that completes a textual sequence that includes the inputs. For instance, the machine-learned models can be configured to generate the outputs to complete a sentence, paragraph, or portion of text that follows from a portion of text represented by inputs.

In some implementations, the task can be an instruction following task. The machine-learned models can be configured to process the inputs that represent instructions to perform a function and to generate the outputs that advance a goal of satisfying the instruction function (e.g., at least a step of a multi-step procedure to perform the function). The outputs can represent data of the same or of a different modality as the inputs. For instance, the inputs can represent textual data (e.g., natural language instructions for a task to be performed) and the machine-learned models can process the inputs to generate the outputs that represent textual data responsive to the instructions (e.g., natural language responses, programming language responses, machine language responses, etc.). The inputs can represent image data (e.g., image-based instructions for a task to be performed, optionally accompanied by textual instructions) and the machine-learned models can process the inputs to generate the outputs that represent textual data responsive to the instructions (e.g., natural language responses, programming language responses, machine language responses, etc.).

One or more outputs can be iteratively or recursively generated to sequentially process and accomplish steps toward accomplishing the requested functionality. For instance, an initial output can be executed by an external system or be processed by the machine-learned models to complete an initial step of performing a function. Multiple steps can be performed, with a final output being obtained that is responsive to the initial instructions.

In some implementations, the task can be a question answering task. The machine-learned models can be configured to process the inputs that represent a question to answer and to generate the outputs that advance a goal of returning an answer to the question (e.g., at least a step of a multi-step procedure to perform the function). The outputs can represent data of the same or of a different modality as the inputs. For instance, the inputs can represent textual data (e.g., natural language instructions for a task to be performed) and the machine-learned models can process the inputs to generate the outputs that represent textual data responsive to the question (e.g., natural language responses, programming language responses, machine language responses, etc.). The inputs can represent image data (e.g., image-based instructions for a task to be performed, optionally accompanied by textual instructions) and the machine-learned models can process the inputs to generate the outputs that represent textual data responsive to the question (e.g., natural language responses, programming language responses, machine language responses, etc.). One or more outputs can be iteratively or recursively generated to sequentially process and accomplish steps toward answering the question. For instance, an initial output can be executed by an external system or be processed by the machine-learned models to complete an initial step of obtaining an answer to the question (e.g., querying a database, performing a computation, executing a script, etc.). Multiple steps can be performed, with a final output being obtained that is responsive to the question.

In some implementations, the task can be an image generation task. The machine-learned models can be configured to process the inputs that represent context regarding a desired portion of image content. The context can include text data, image data, audio data, etc. Machine-learned models can be configured to generate the outputs that represent image data that depicts imagery related to the context. For instance, the machine-learned models can be configured to generate pixel data of an image. Values for channels associated with the pixels in the pixel data can be selected based on the context (e.g., based on a probability determined based on the context).

In some implementations, the task can be an audio generation task. Machine-learned models can be configured to process the inputs that represent context regarding a desired portion of audio content. The context can include text data, image data, audio data, etc. The machine-learned models can be configured to generate the outputs that represent audio data related to the context. For instance, the machine-learned models can be configured to generate waveform data in the form of an image (e.g., a spectrogram). Values for channels associated with pixels of the image can be selected based on the context. The machine-learned models can be configured to generate waveform data in the form of a sequence of discrete samples of a continuous waveform. Values of the sequence can be selected based on the context (e.g., based on a probability determined based on the context).

In some implementations, the task can be a data generation task. Machine-learned models can be configured to process the inputs that represent context regarding a desired portion of data (e.g., data from various data domains, such as sensor data, image data, multimodal data, statistical data, etc.). The desired data can be, for instance, synthetic data for training other machine-learned models. The context can include arbitrary data types. The machine-learned models can be configured to generate the outputs that represent data that aligns with the desired data. For instance, the machine-learned models can be configured to generate data values for populating a dataset. Values for the data objects can be selected based on the context (e.g., based on a probability determined based on the context).

The user computing system 102 can include a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing system 100.

The central intelligence layer can communicate with a central device data layer. The central device data layer can be a centralized repository of data for the computing system 100. The central device data layer may communicate with a number of other components of the computing device, such as, for example, one or more sensors, a context manager, a device state component, and/or additional components. In some implementations, the central device data layer can communicate with each device component using an API (e.g., a private API).

FIG. 12B depicts a block diagram of an example computing system 50 that performs model-generated image generation according to example embodiments of the present disclosure. In particular, the example computing system 50 can include one or more computing devices 52 that can be utilized to obtain, and/or generate, one or more datasets that can be processed by a sensor processing system 60 and/or an output determination system 80 to feedback to a user that can provide information on features in the one or more obtained datasets. The one or more datasets can include image data, text data, audio data, multimodal data, latent encoding data, etc. The one or more datasets may be obtained via one or more sensors associated with the one or more computing devices 52 (e.g., one or more sensors in the computing device 52). Additionally and/or alternatively, the one or more datasets can be stored data and/or retrieved data (e.g., data retrieved from a web resource). For example, images, text, and/or other content items may be interacted with by a user. The interacted with content items can then be utilized to generate one or more determinations.

The one or more computing devices 52 can obtain, and/or generate, one or more datasets based on image capture, sensor tracking, data storage retrieval, content download (e.g., downloading an image or other content item via the internet from a web resource), and/or via one or more other techniques. The one or more datasets can be processed with a sensor processing system 60. The sensor processing system 60 may perform one or more processing techniques using one or more machine-learned models, one or more search engines, and/or one or more other processing techniques. The one or more processing techniques can be performed in any combination and/or individually. The one or more processing techniques can be performed in series and/or in parallel. In particular, the one or more datasets can be processed with a context determination block 62, which may determine a context associated with one or more content items. The context determination block 62 may identify and/or process metadata, user profile data (e.g., preferences, user search history, user browsing history, user purchase history, and/or user input data), previous interaction data, global trend data, location data, time data, and/or other data to determine a particular context associated with the user. The context can be associated with an event, a determined trend, a particular action, a particular type of data, a particular environment, and/or another context associated with the user and/or the retrieved or obtained data.

The sensor processing system 60 may include an image preprocessing block 64. The image preprocessing block 64 may be utilized to adjust one or more values of an obtained and/or received image to prepare the image to be processed by one or more machine-learned models and/or one or more search engines 74. The image preprocessing block 64 may resize the image, adjust saturation values, adjust resolution, strip and/or add metadata, and/or perform one or more other operations.

In some implementations, the sensor processing system 60 can include one or more machine-learned models, which may include a detection model 66, a segmentation model 68, a classification model 70, an embedding model 72, and/or one or more other machine-learned models. For example, the sensor processing system 60 may include one or more detection models 66 that can be utilized to detect particular features in the processed dataset. In particular, one or more images can be processed with the one or more detection models 66 to generate one or more bounding boxes associated with detected features in the one or more images.

Additionally and/or alternatively, one or more segmentation models 68 can be utilized to segment one or more portions of the dataset from the one or more datasets. For example, the one or more segmentation models 68 may utilize one or more segmentation masks (e.g., one or more segmentation masks manually generated and/or generated based on the one or more bounding boxes) to segment a portion of an image, a portion of an audio file, and/or a portion of text. The segmentation may include isolating one or more detected objects and/or removing one or more detected objects from an image. In some implementations, the object(s) may be segmented from the input images to isolate the features of interest.

The one or more classification models 70 can be utilized to process image data, text data, audio data, latent encoding data, multimodal data, and/or other data to generate one or more classifications. The one or more classification models 70 can include one or more image classification models, one or more object classification models, one or more text classification models, one or more audio classification models, and/or one or more other classification models. The one or more classification models 70 can process data to determine one or more classifications. In some implementations, the object(s) may be classified by processing the one or more input images. The classification may then be utilized to identify whether a prompt is associated with the particular object (e.g., if a prompt includes the classification, the generative model may render the object). Alternatively and/or additionally, the output model-generated image(s) may be processed with one or more classification models 70 to evaluate the quality of the model-generated image(s) and/or to annotate the model-generated image(s). In some implementations, the classification model 70 may classify whether an image appears to be real and/or may classify the objects in the image.

In some implementations, data may be processed with one or more embedding models 72 to generate one or more embeddings. For example, one or more images can be processed with the one or more embedding models 72 to generate one or more image embeddings in an embedding space. The one or more image embeddings may be associated with one or more image features of the one or more images. In some implementations, the one or more embedding models 72 may be configured to process multimodal data to generate multimodal embeddings. The one or more embeddings can be utilized for classification, search, and/or learning embedding space distributions. The one or more embedding models 72 may be utilized to generate the unique identifiers.

The sensor processing system 60 may include one or more search engines 74 that can be utilized to perform one or more searches. The one or more search engines 74 may crawl one or more databases (e.g., one or more local databases, one or more global databases, one or more private databases, one or more public databases, one or more specialized databases, and/or one or more general databases) to determine one or more search results. The one or more search engines 74 may perform feature matching, text based search, embedding based search (e.g., k-nearest neighbor search), metadata based search, multimodal search, web resource search, image search, text search, and/or application search.

Additionally and/or alternatively, the sensor processing system 60 may include one or more multimodal processing blocks 76, which can be utilized to aid in the processing of multimodal data. The one or more multimodal processing blocks 76 may include generating a multimodal query and/or a multimodal embedding to be processed by one or more machine-learned models and/or one or more search engines 74.

The output(s) of the sensor processing system 60 can then be processed with an output determination system 80 to determine one or more outputs to provide to a user. The output determination system 80 may include heuristic based determinations, machine-learned model based determinations, user selection based determinations, and/or context based determinations.

The output determination system 80 may determine how and/or where to provide the one or more search results in a search results interface 82. Additionally and/or alternatively, the output determination system 80 may determine how and/or where to provide the one or more machine-learned model outputs in a machine-learned model output interface 84. In some implementations, the one or more search results and/or the one or more machine-learned model outputs may be provided for display via one or more user interface elements. The one or more user interface elements may be overlayed over displayed data. For example, one or more detection indicators may be overlayed over detected objects in a viewfinder. The one or more user interface elements may be selectable to perform one or more additional searches and/or one or more additional machine-learned model processes. In some implementations, the user interface elements may be provided as specialized user interface elements for specific applications and/or may be provided uniformly across different applications. The one or more user interface elements can include pop-up displays, interface overlays, interface tiles and/or chips, carousel interfaces, audio feedback, animations, interactive widgets, and/or other user interface elements.

Additionally and/or alternatively, data associated with the output(s) of the sensor processing system 60 may be utilized to generate and/or provide an augmented-reality experience and/or a virtual-reality experience 86. For example, the one or more obtained datasets may be processed to generate one or more augmented-reality rendering assets and/or one or more virtual-reality rendering assets, which can then be utilized to provide an augmented-reality experience and/or a virtual-reality experience 86 to a user. The augmented-reality experience may render information associated with an environment into the respective environment. Alternatively and/or additionally, objects related to the processed dataset(s) may be rendered into the user environment and/or a virtual environment. Rendering dataset generation may include training one or more neural radiance field models to learn a three-dimensional representation for one or more objects.

In some implementations, one or more action prompts 88 may be determined based on the output(s) of the sensor processing system 60. For example, a search prompt, a purchase prompt, a generate prompt, a reservation prompt, a call prompt, a redirect prompt, and/or one or more other prompts may be determined to be associated with the output(s) of the sensor processing system 60. The one or more action prompts 88 may then be provided to the user via one or more selectable user interface elements. In response to a selection of the one or more selectable user interface elements, a respective action of the respective action prompt may be performed (e.g., a search may be performed, a purchase application programming interface may be utilized, and/or another application may be opened).

In some implementations, the one or more datasets and/or the output(s) of the sensor processing system 60 may be processed with one or more generative models 90 to generate a model-generated content item that can then be provided to a user. The generation may be prompted based on a user selection and/or may be automatically performed (e.g., automatically performed based on one or more conditions, which may be associated with a threshold amount of search results not being identified).

The one or more generative models 90 can include language models (e.g., large language models and/or vision language models), image generation models (e.g., text-to-image generation models and/or image augmentation models), audio generation models, video generation models, graph generation models, and/or other data generation models (e.g., other content generation models). The one or more generative models 90 can include one or more transformer models, one or more convolutional neural networks, one or more recurrent neural networks, one or more feedforward neural networks, one or more generative adversarial networks, one or more self-attention models, one or more embedding models, one or more encoders, one or more decoders, and/or one or more other models. In some implementations, the one or more generative models 90 can include one or more autoregressive models (e.g., a machine-learned model trained to generate predictive values based on previous behavior data) and/or one or more diffusion models (e.g., a machine-learned model trained to generate predicted data based on generating and processing distribution data associated with the input data).

The one or more generative models 90 can be trained to process input data and generate model-generated content items, which may include a plurality of predicted words, pixels, signals, and/or other data. The model-generated content items may include novel content items that are not the same as any pre-existing work. The one or more generative models 90 can leverage learned representations, sequences, and/or probability distributions to generate the content items, which may include phrases, storylines, settings, objects, characters, beats, lyrics, and/or other aspects that are not included in pre-existing content items.

The one or more generative models 90 may include a vision language model.

The vision language model can be trained, tuned, and/or configured to process image data and/or text data to generate a natural language output. The vision language model may leverage a pre-trained large language model (e.g., a large autoregressive language model) with one or more encoders (e.g., one or more image encoders and/or one or more text encoders) to provide detailed natural language outputs that emulate natural language composed by a human.

The vision language model may be utilized for zero-shot image classification, few shot image classification, image captioning, multimodal query distillation, multimodal question and answering, and/or may be tuned and/or trained for a plurality of different tasks. The vision language model can perform visual question answering, image caption generation, feature detection (e.g., content monitoring (e.g., for inappropriate content)), object detection, scene recognition, and/or other tasks.

The vision language model may leverage a pre-trained language model that may then be tuned for multimodality. Training and/or tuning of the vision language model can include image-text matching, masked-language modeling, multimodal fusing with cross attention, contrastive learning, prefix language model training, and/or other training techniques. For example, the vision language model may be trained to process an image to generate predicted text that is similar to ground truth text data (e.g., a ground truth caption for the image). In some implementations, the vision language model may be trained to replace masked tokens of a natural language template with textual tokens descriptive of features depicted in an input image. Alternatively and/or additionally, the training, tuning, and/or model inference may include multi-layer concatenation of visual and textual embedding features. In some implementations, the vision language model may be trained and/or tuned via jointly learning image embedding and text embedding generation, which may include training and/or tuning a system to map embeddings to a joint feature embedding space that maps text features and image features into a shared embedding space. The joint training may include image-text pair parallel embedding and/or may include triplet training. In some implementations, the images may be utilized and/or processed as prefixes to the language model.

The one or more generative models 90 may be stored on-device and/or may be stored on a server computing system. In some implementations, the one or more generative models 90 can perform on-device processing to determine suggested searches, suggested actions, and/or suggested prompts. The one or more generative models 90 may include one or more compact vision language models that may include less parameters than a vision language model stored and operated by the server computing system. The compact vision language model may be trained via distillation training. In some implementations, the visional language model may process the display data to generate suggestions. The display data can include a single image descriptive of a screenshot and/or may include image data, metadata, and/or other data descriptive of a period of time preceding the current displayed content (e.g., the applications, images, videos, messages, and/or other content viewed within the past 30 seconds). The user computing device may generate and store a rolling buffer window (e.g., 30 seconds) of data descriptive of content displayed during the buffer. Once the time has elapsed, the data may be deleted. The rolling buffer window data may be utilized to determine a context, which can be leveraged for query, content, action, and/or prompt suggestion.

In some implementations, the generative models 90 can include machine-learned sequence processing models. An example system can pass inputs to sequence processing models. Sequence processing models can include one or more machine-learned components. Sequence processing models can process the data from inputs to obtain an input sequence.

Input sequence can include one or more input elements obtained from inputs. The sequence processing model can process the input sequence using prediction layers to generate an output sequence. The output sequence can include one or more output elements generated based on input sequence. The system can generate outputs based on output sequence.

Sequence processing models can include one or multiple machine-learned model components configured to ingest, generate, or otherwise reason over sequences of information. For example, some example sequence processing models in the text domain are referred to as “Large Language Models,” or LLMs. See, e.g., PaLM 2 Technical Report, Google, https://ai.google/static/documents/palm2techreport.pdf (n.d.). Other example sequence processing models can operate in other domains, such as image domains, see, e.g., Dosovitskiy et al., An Image is Worth 16×16 Words: Transformers for Image Recognition at Scale, arXiv:2010.11929v2 (Jun. 3, 2021), audio domains, see, e.g., Agostinelli et al., MusicLM: Generating Music From Text, arXiv:2301.11325v1 (Jan. 26, 2023), biochemical domains, see, e.g., Jumper et al., Highly accurate protein structure prediction with AlphaFold, 596 Nature 583 (Aug. 26, 2021), by way of example. Sequence processing models can process one or multiple types of data simultaneously. Sequence processing models can include relatively large models (e.g., more parameters, computationally expensive, etc.), relatively small models (e.g., fewer parameters, computationally lightweight, etc.), or both.

In general, sequence processing models can obtain an input sequence using data from inputs. For instance, input sequence can include a representation of data from inputs 2 in a format understood by sequence processing models. One or more machine-learned components of sequence processing models can ingest the data from inputs, parse the data into pieces compatible with the processing architectures of sequence processing models (e.g., via “tokenization”), and project the pieces into an input space associated with prediction layers (e.g., via “embedding”).

Sequence processing models can ingest the data from inputs and parse the data into a sequence of elements to obtain input sequence. For example, a portion of input data from inputs can be broken down into pieces that collectively represent the content of the portion of the input data. The pieces can provide the elements of the sequence.

In some implementations, processing the input data can include tokenization. For example, a tokenizer may process a given portion of an input source and output a series of tokens (e.g., corresponding to input elements) that represent the portion of the input source. Various approaches to tokenization can be used. For instance, textual input sources can be tokenized using a byte-pair encoding (BPE) technique. See. e.g., Kudo et al., SentencePiece: A simple and language independent subword tokenizer and detokenizer for Neural Text Processing, Proceedings of the 2018 Conference on Empirical Methods in Natural Language Processing (System Demonstrations), pages 66-71 (Oct. 31-Nov. 4, 2018), https://aclanthology.org/D18-2012.pdf. Image-based input sources can be tokenized by extracting and serializing patches from an image.

In general, arbitrary data types can be serialized and processed into an input sequence.

Prediction layers can predict one or more output elements based on the input elements. Prediction layers can include one or more machine-learned model architectures, such as one or more layers of learned parameters that manipulate and transform the inputs to extract higher-order meaning from, and relationships between, input elements. In this manner, for instance, example prediction layers can predict new output elements in view of the context provided by input sequence.

Prediction layers can evaluate associations between portions of input sequence and a particular output element. These associations can inform a prediction of the likelihood that a particular output follows the input context. For example, consider the textual snippet, “The carpenter's toolbox was small and heavy. It was full of _____. ” Example prediction layers can identify that “It” refers back to “toolbox” by determining a relationship between the respective embeddings. Example prediction layers can also link “It” to the attributes of the toolbox, such as “small” and “heavy.” Based on these associations, prediction layers can, for instance, assign a higher probability to the word “nails” than to the word “sawdust.”

A transformer is an example architecture that can be used in prediction layers. See, e.g., Vaswani et al., Attention Is All You Need, arXiv:1706.03762v7 (Aug. 2, 2023). A transformer is an example of a machine-learned model architecture that uses an attention mechanism to compute associations between items within a context window. The context window can include a sequence that contains input sequence and potentially one or more output elements. A transformer block can include one or more attention layers and one or more post-attention layers (e.g., feedforward layers, such as a multi-layer perceptron).

Prediction layers can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layers can leverage various kinds of artificial neural networks that can understand or generate sequences of information.

Output sequence can include or otherwise represent the same or different data types as input sequence. For instance, input sequence can represent textual data, and output sequence can represent textual data. The input sequence can represent image, audio, or audiovisual data, and output sequence can represent textual data (e.g., describing the image, audio, or audiovisual data). It is to be understood that prediction layers, and any other interstitial model components of sequence processing models, can be configured to receive a variety of data types in input sequences and output a variety of data types in output sequences.

The output sequence can have various relationships to an input sequence. Output sequence can be a continuation of input sequence. The output sequence can be complementary to the input sequence. The output sequence can translate, transform, augment, or otherwise modify input sequence. The output sequence can answer, evaluate, confirm, or otherwise respond to input sequence. The output sequence can implement (or describe instructions for implementing) an instruction provided via an input sequence.

The output sequence can be generated autoregressively. For instance, for some applications, an output of one or more prediction layers can be passed through one or more output layers (e.g., softmax layer) to obtain a probability distribution over an output vocabulary (e.g., a textual or symbolic vocabulary) conditioned on a set of input elements in a context window. In this manner, for instance, the output sequence can be autoregressively generated by sampling a likely next output element, adding that element to the context window, and re-generating the probability distribution based on the updated context window, and sampling a likely next output element, and so forth.

The output sequence can also be generated non-autoregressively. For instance, multiple output elements of the output sequence can be predicted together without explicit sequential conditioning on each other. See, e.g., Saharia et al., Non-Autoregressive Machine Translation with Latent Alignments, arXiv:2004.07437v3 (Nov. 16, 2020).

The output sequence can include one or multiple portions or elements. In an example content generation configuration, the output sequence can include multiple elements corresponding to multiple portions of a generated output sequence (e.g., a textual sentence, values of a discretized waveform, computer code, etc.). In an example classification configuration, the output sequence can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

The output determination system 80 may process the one or more datasets and/or the output(s) of the sensor processing system 60 with a data augmentation block 92 to generate augmented data. For example, one or more images can be processed with the data augmentation block 92 to generate one or more augmented images. The data augmentation can include data correction, data cropping, the removal of one or more features, the addition of one or more features, a resolution adjustment, a lighting adjustment, a saturation adjustment, and/or other augmentation.

In some implementations, the one or more datasets and/or the output(s) of the sensor processing system 60 may be stored based on a data storage block 94 determination.

The output(s) of the output determination system 80 can then be provided to a user via one or more output components of the user computing device 52. For example, one or more user interface elements associated with the one or more outputs can be provided for display via a visual display of the user computing device 52.

The processes may be performed iteratively and/or continuously. One or more user inputs to the provided user interface elements may condition and/or affect successive processing loops.

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

1. A computing system for image generation, the system comprising:
one or more processors; and
one or more non-transitory computer-readable media that collectively store instructions that, when executed by the one or more processors, cause the computing system to perform operations, the operations comprising:
obtaining input data, wherein the input data comprises one or more input images, wherein the one or more input images are descriptive of a particular object;
processing the input data with an image generation model to generate output data, wherein the image generation model has been trained to generate a set of model-generated images based on an input, wherein the output data comprises a plurality of output model-generated images, wherein the plurality of output model-generated images are descriptive of the particular object in one or more environments, wherein processing input data with the image generation model to generate the output data comprises:
tuning a set of parameters of the image generation model based on the one or more input images;
embedding an association between a model-readable token and the set of parameters within the image generation model;
generating a plurality of prompts that comprise the model-readable token; and
generating, by processing the plurality of prompts with the image generation model, the plurality of output model-generated images based at least in part on the set of parameters tuned based on the one or more input images, wherein the set of parameters render the particular object based on the image generation model processing the model-readable token; and
providing at least a subset of the plurality of output model-generated images as output.

2. The system of claim 1, wherein the one or more environments differ from one or more background environments of the one or more input images.

3. The system of claim 1, wherein the operations further comprise:
processing the plurality of output model-generated images and the one or more input images to determine an object metric for each of the plurality of output model-generated images, wherein the object metric is descriptive of a determined similarity between the particular object as depicted in the one or more input images and the particular object as depicted in a respective output model-generated image of the plurality of output model-generated images; and
determining the subset of the plurality of output model-generated images to output based on the plurality of object metrics.

4. The system of claim 1, wherein the operations further comprise:
processing the plurality of output model-generated images to determine a realism metric for each of the plurality of output model-generated images, wherein the realism metric is descriptive of a determined realism of a respective output model-generated image of the plurality of output model-generated images; and
determining the subset of the plurality of output model-generated images to output based on the plurality of realism metrics.

5. The system of claim 1, wherein the image generation model comprises a plurality of multi-layer perceptron blocks to perform color prediction and density prediction for object rendering.

6. The system of claim 1, wherein tuning the set of parameters comprises:
generating a first model-generated image with the image generation model;
evaluating a loss function that evaluates a difference between the first model-generated image and the one or more input images; and
adjusting one or more parameters of the set of parameters based at least in part on the loss function.

7. The system of claim 1, wherein the operations further comprise:
obtaining a search query;
determining the search query is associated with the particular object; and
providing one or more output model-generated images of the plurality of output model-generated images for display in a search results interface.

8. The system of claim 1, wherein the operations further comprise:
obtaining content data from a user computing system, wherein the content data is descriptive of one or more content items accessed by the user computing system;
determining the content data is associated with the particular object; and
providing one or more output model-generated images of the plurality of output model-generated images to the user computing system.

9. The system of claim 1, wherein the input data comprises a first set of input images associated with a first object and a second set of images associated with a second object, and wherein the plurality of output model-generated images are descriptive of the first object and the second object in the one or more environments.

10. The system of claim 1, wherein the image generation model comprises at least one of a diffusion model or a token-based transformer model.

11. A computer-implemented method for generating model-generated images with an object, the method comprising:
obtaining, by a computing system comprising one or more processors, a plurality of input images, wherein each of the plurality of input images depict the object;
obtaining, by the computing system, a pre-trained image generation model, wherein the pre-trained image generation model was trained to process an input and generate an output image that comprises predicted pixels;
adjusting, by the computing system, a set of parameters based on the plurality of images and the pre-trained image generation model;
associating, by the computing system, the set of parameters with a unique identifier;
generating, by the computing system, a plurality of prompts comprising the unique identifier and a plurality of different terms associated with a plurality of different settings;
generating, by the computing system, a plurality of model-generated images with the set of parameters and the pre-trained image generation model based on processing the plurality of prompts with the pre-trained image generation model and the set of parameters, wherein the plurality of model-generated images comprise predicted image data that depicts the object in one or more environments; and
providing, by the computing system, at least a subset of the plurality of model-generated images as output.

12. The method of claim 11, wherein the set of parameters are different from a plurality of pre-tuned parameters of the pre-trained image generation model.

13. The method of claim 11, wherein adjusting, by the computing system, the set of parameters based on the plurality of images and the pre-trained image generation model comprises:
generating a plurality of training output images with the pre-trained image generation model and the set of parameters;
evaluating a loss function that evaluates a difference between one or more respective training output images of the plurality of training output images and one or more of the plurality of input images; and
adjusting one or more parameters of the set of parameters based at least in part on the loss function.

14. The method of claim 11, wherein generating the plurality of training output images with the pre-trained image generation model and the set of parameters comprises:
obtaining a prompt associated with the object, wherein the prompt comprises text data and the unique identifier; and
processing the prompt with the pre-trained image generation model and the set of parameters to generate the plurality of training output images, wherein the object is rendered based on the set of parameters in response to the pre-trained image generation model processing the unique identifier.

15. The method of claim 11, wherein the plurality of input images depict the object from different perspectives.

16. The method of claim 11, wherein the plurality of input images depict the object in different environments.

17. One or more non-transitory computer-readable media that collectively store instructions that, when executed by one or more computing devices, cause the one or more computing devices to perform operations, the operations comprising:
obtaining a plurality of input images, wherein the plurality of input images are descriptive of a particular object;
obtaining a pre-trained text-to-image generative model, wherein the pre-trained text-to-image generative model was trained to process an input and generate an output image that comprises predicted pixels;
processing the plurality of input images with the pre-trained text-to-image generative model to adjust one or more parameters to generate a specialized text-to-image model and to generate a unique identifier associated with the particular object, wherein the specialized text-to-image model is trained to generate image data associated with the particular object in response to processing the unique identifier;
obtaining a prompt, wherein the prompt comprises text data and the unique identifier;
processing the prompt with the specialized text-to-image model to generate one or more model-generated images, wherein the one or more model-generated images comprise the particular object in an environment, wherein the environment is generated based at least in part on the text data; and
providing the one or more model-generated images as output.

18. The one or more non-transitory computer-readable media of claim 17, wherein the text data is descriptive of a request for a particular type of environment be rendered, and wherein the environment of the one or more model-generated images is of the particular type of environment.

19. The one or more non-transitory computer-readable media of claim 17, wherein the unique identifier comprises at least one of a set of characters or one or more embedding values.

20. The one or more non-transitory computer-readable media of claim 17, wherein the one or more model-generated images comprise the particular object depicted in a different perspective from the one or more particular perspectives of the plurality of input images.
